(19) United States
(12) Patent Application Publication
(10) Pub. No.: US 2013/0029872 A1
(43) Pub. Date: Jan. 31, 2013

(54) ARRAY FOR DETECTING BIOLOGICAL SUBSTANCE, ASSAY SYSTEM AND ASSAY METHOD

(71) Applicants: Yu Ishige, Tokyo (JP); Masao Kamahori, Kokubunji (JP); Yusuke Goto, Kashiwa (JP)

(72) Inventors: Yu Ishige, Tokyo (JP); Masao Kamahori, Kokubunji (JP); Yusuke Goto, Kashiwa (JP)

(21) Appl. No.: 13/639,350

(22) PCT Filed: Apr. 4, 2011
(86) PCT No.: PCT/JP2011/001991

§ 371 Date: Oct. 4, 2012

(30) Foreign Application Priority Data
Apr. 9, 2010 (JP) 2010-090024
Mar. 17, 2011 (JP) 2011-058662

(51) Int. Cl. C40B 40/10; C40B 30/04

(52) U.S. Cl. 506/9; 506/18

(57) ABSTRACT

Provided are a device, whereby cells, a bacterium or a virus can be quantified in a single unit, an assay system and an assay method. A subject to be assayed such as cells, a bacterium or a virus, which are present on a sensor, can be quantified by using a sensor equipped with multiple electrodes, said electrodes being similar in size to the subject to be assayed, detecting, concerning each electrode, the presence or absence of the subject in the vicinity of the electrode, and adding up the electrodes in which the subject is detected.

### TECHNICAL FIELD

The present invention relates to an assay system and an assay method for performing electrical measurement and assaying microorganisms and biological material with high precision and high sensitivity.

### BACKGROUND ART

Recently, rapid test kits using immune-chromatography (for example, Patent Literature 1) for the purpose of a pregnancy test and a flu test as a basic principle have been prevalently distributed. These kits have advantages in that users can know the results within a short period of time such as several minutes to several tens of minutes by a simple operation of dropping a specimen into a specimen introduction part. A basic configuration of the kit is illustrated in FIG. 1, and when a specimen is dropped into a specimen introduction part 102, a labeled antibody 108 within a conjugate pad 103 migrates within a membrane 104, along with the specimen. As a labeled substance, a gold colloid or a latex microparticle is used. When a subject to be assayed is present within a specimen, the labeled antibody 108 is coupled with an immobilized antibody 109 of a test line 105, having the subjects to be assayed interposed therebetween, and the test line 105 generates colors by aggregation of the labeled substances. In addition, the labeled antibody 108 is coupled with the immobilized antibody 110 of a control line 106 and the control line 106 generates colors, regardless of whether the subjects to be assayed are present within a specimen. As a result, it can be appreciated whether the reaction ends based on the color generation of the control line 106 and it can be appreciated whether the subjects to be assayed are present within a specimen based on whether the test line 105 generates colors. The decision based on the naked eye is simple, but there may be a case in which a degree of color generation may be digitalized using a separate apparatus so as to obtain quantitativity (for example, Patent Literature 2).

As a method for detecting biological materials using an antibody, a sandwich assay used for an enzyme-linked immunosorbent assay (ELISA), and the like, has been well known (for example, Non-Patent Literature 1). In the enzyme-linked immunosorbent assay (ELISA), a specimen and labeled antibodies are injected into a substrate to which immobilized antibodies are fixed, free labeled antibodies are removed by washing the substrate after the specimen and the labeled antibodies react with each other for a predetermined time, and only the labeled antibody coupled with the immobilized antibody, having the subjects to be assayed in the specimen interposed therebetween, is used. Next, a substrate liquid is injected, a marker enzyme and a substrate react with each other, and a degree of color generation of a reaction product is assayed. A concentration of the subjects to be assayed is obtained by using the relationship between the previously obtained concentration of the subjects to be assayed and the degree of color generation.

The sandwich assay includes a so-called washing process of removing the labeled antibodies that are not coupled with the immobilized antibodies, but there is a method called a homogeneous assay that does not include the washing process.

In a latex agglutination assay, the specimen is injected into a liquid in which the latex particulate to which the antibodies are immobilized is dispersed and the agglutination of the latex microparticle based on the subjects to be assayed in the specimen is assayed by a change in absorbance, and the like (for example, Patent Literature 3).

In a Luminescent oxygen channeling immunoassay (LOCI) (for example, Patent Literature 4), particulates A and B to which antibodies that recognize different portions of the subject to be assayed is immobilized, respectively are prepared. When mixing the specimen and the particulates A and B, the particulates A and B are coupled with each other, having the subjects to be assayed in the specimen interposed therebetween, but in this case, the emission generated only when the particulates A and B are closely adjacent to each other is detected and the subject to be assayed is quantified. When the particulates A and B are far away from each other, the emission is not generated, and thus a process of removing the particulate that is not coupled with the subjects to be assayed is not required.

As an immunoassay using only the immobilized antibody without using the labeled antibodies, a surface plasmon resonance (SPR) (for example, Patent Literature 5), a quartz crystal microbalance (QCM) (for example, Patent Literature 6), a capacitance assay (for example, Non-Patent Literature 2), and an Field-effect transistor sensor (for example, Non-Patent Literature 3) have been reported. The SPR is a detection method using surface oozing light and detects the coupling of antibodies immobilized to a surface of a sensor with the subjects as on a change in a plasma resonance angle, based on a change in a refractive index. The QCM is a detection method using a resonance frequency of the quartz oscillator and detects the coupling of antibodies immobilized to a surface of a sensor with the subjects based on a change in resonance frequency via a change in a mass. The capacitance assay detects the coupling of antibodies immobilized to a surface of a sensor with the subjects to be detected based on a change in capacitance. The FET sensor is a method for assaying interfacial potential and detects the coupling of antibodies immobilized to a surface of a sensor with the subjects to be detected based on a change in interfacial potential.

As a method for assaying biological materials using impedance, a method for assaying the quantity and state of cells has been known (for example, Patent Literature 7 and Non-Patent Literature 4). At least two electrodes are present in an aqueous solution and the change in impedance between the electrodes is assayed based on the quantity and adhesion state of the cells on the electrodes. Since a cell membrane has electrically high resistance, it is a basic principle that the impedance between the electrodes increases when cells are present on the electrodes. Further, a device including electrodes having a 50 μm angle arranged in plural and allowing each electrode to assay individual cells, and assaying statistics of behaviors of the cells has been considered.

As the electrodes in which multiple micro electrodes having 100 nm or less are arranged, the electrodes using a polymer or carbon nanotube have been reported (for example, Patent Literature 8 and Patent Literature 9). Making the electrode in a micro form increases a diffusion of substances to a surface area of the electrode to assay most of the redox substances with high sensitivity. For this reason, all of the plurality of electrodes are electrically connected on the substrate and thus are used as one electrode.

### CITATION LIST

### Patent Literature

Patent Literature 1: Japanese Patent Application Laid-Open Publication No. Hei 1 (1989)-32169
Patent Literature 2: Japanese Patent Application Laid-Open Publication No. Hei 10 (1998)-274624
Patent Literature 3: Japanese Patent Application Laid-Open Publication No. Hei 9 (1999)-274041
Patent Literature 4: EP 0515194 A2
Patent Literature 5: Japanese Patent Application Laid-Open Publication No. Hei 1 (1989)-138443
Patent Literature 6: Japanese Patent Application Laid-Open Publication No. Sho 63 (1988)-243877
Patent Literature 7: U.S. Pat. No. 7,192,752
Patent Literature 8: US 2005/0230270
Patent Literature 9: Japanese Unexamined Patent Application Publication No. 2006-520469

### Non-Patent Literature

Non-Patent Literature 1: Immunochemistry 1971, 8, 871-874
Non-Patent Literature 2: Anal. Chem. 1997, 69, 3651-3657
Non-Patent Literature 3: Analyst, 2002, 127, 1137-1151
Non-Patent Literature 4: Sensors, 2003, Proceedings of IEEE, Impedance Based Biosensor Array for Monitoring Mammalian Cell Behavior, Huang, X. et al.

### SUMMARY OF INVENTION

### Technical Problem

When using the related art, it is impossible to quantify cells, bacteria, and viruses in a single unit.

In the immune-chromatography using the aggregation of gold colloid, a change in color is first generated when multiple labeled substances is aggregated. This is also the same even in the latex agglutination assay. For this reason, the sensitivity is insufficient upon performing assay in a single unit.

The sandwich assay is generally a high-sensitivity assay method and may perform a detection using one labeled antibody according to a study of a reaction system. However, the labeled antibodies all of which are not removed by the washing have so-called background signals that generate colors, and it is difficult to perform the assay in a single unit due to the presence of the background signal. The effect of the background signals is the same even in the luminescent oxygen channeling immunoassay of the homogeneous analysis.

In the SPR, in order to assay the refractive index approximately corresponding to a wavelength from the surface of the sensor, the attachment of substances (impurities) in addition to substances to be assayed on the surface of the sensor may be the background signal. In the QCM, in order to assay a mass coupled on the surface of the sensor, the attachment of impurities may be likewise the background signal. The Field-effect transistor sensor is sensitive to the change in about 1 to 10 nm from the surface of the sensor from the relationship of Debye-length and the attachment of impurities may be likewise the background signal. In the capacitance assay, capacity of a planar capacitor is in inverse proportion to a distance, and therefore the change in capacitance is also in inverse proportion to a size of the subject to be assayed. For this reason, the capacitance is changed even by the attachment of impurities smaller than the subjects to be assayed to the sensor unit to generate the background signal. That is, these assay methods do not control the size of the subjects to be assayed that can be assayed by the sensor and thus do not effectively suppress the background signal.

In the cell assay using impedance, as described in Patent Literature 7, an electrode pair even larger than the cell is used to perform the assay in the state in which the plurality of cells is present on one electrode pair. For this reason, it is difficult to differentiate the quantity, size, adhesion degree, background, and the like of the cell and to assay the cell in a single unit. As described in Non-Patent Literature 4, a device including electrodes having 30 to 50 μm arranged in plural and assaying the impedance of cells one by one and observing a state of individual cells has been reported, but a device counting cells has not yet been considered. For example, there may be a device in which counter electrodes are disposed, a device in which probes such as antibodies, and the like, are not present on a surface of an electrode, a device in which the number of electrodes is less than 100, and the like. That is, in the cell assay using impendence up to now, a size and a shape of an electrode, surface modification, and the number of electrodes suitable to count the subject to be assayed are not considered.

Until now, the micro electrode is for high sensitivity of redox current as described above and therefore needs not to be individually wired and cannot assay the subjects to be assayed in a single unit.

The present invention provides an assay system and an assay method for counting and quantifying cells, bacteria, and viruses in a single unit.

### Solution to Problem

In a representative form of the present invention, there are an array including a substrate, multiple electrodes disposed on a surface of the substrate, wirings connected with each of the multiple electrodes and disposed at an opposite side of the surface of the substrate, and a probe capturing the subjects to be assayed on the electrodes and an assay system using the same. Further, the presence or absence of the subjects to be assayed in the vicinity of each electrode is detected using a sensor having the shape of the array in which the electrodes having approximately the same size so as to make a pair with the subjects to be assayed such as cells, bacteria, viruses, and the like, are arranged in plural. In addition, the quantity of the subjects to be assayed that are present on the sensor is assayed by adding up the subjects to be assayed to the number of electrodes detecting the subjects to be. The presence or absence of the subject to be assayed in the vicinity of the electrode is determined by assaying AC impedance between counter electrodes present in a solution in a state in which the surface of the electrode is in contact with the solution and comparing the AC impedance with the electrodes in the vicinity of which the subjects to be assayed are not present.

### Advantageous Effect of Invention

According to the present invention, it is possible to selectively detect the subjects to be assayed having a size similar to that of the electrodes by making the size of the subjects to be assayed such as cells, bacteria, viruses, and the like, and the electrodes approximately the same and assaying the AC impedance. Herein, since it is known that the multiple subjects to be assayed are not present in the electrodes, it is possible to determine the presence or absence of the subjects to be assayed and when the background signals that are a problem in the related art is smaller than the change in signals generated due to the presence of the subject to be assayed in the vicinity of the electrode, it is possible to remove the background signals and considerably suppress the effect on the assayed values of the background signals. Further, it is possible to considerably suppress the effect on the assayed values of the deviations of the change in signals due to the individual difference of the subjects to be assayed that is a problem like the background signals by deciding the presence or absence of the subjects to be assayed. In addition, it is possible to obtain the quantity of the subjects to be assayed in the specimen by adding up the subjects to be assayed to the number of electrodes detecting the subjects to be assayed and assaying the quantity of the subjects to be assayed present on the sensor. In this case, as described above, since it is possible to remove the background signals for each electrode or the deviations of the change in signals due to the individual difference of the subjects to be assayed, it is possible to perform the assay with higher precision than the related art.

### BRIEF DESCRIPTION OF DRAWINGS

FIG. 1 is a diagram schematically illustrating a simple test kit using immune-chromatography.

FIG. 2 is a diagram illustrating an example of an electrode array chip.

FIG. 3 is a cross-sectional view illustrating an example of the electrode array chip.

FIG. 4 is a conceptual diagram illustrating a case in which the antibodies as probes are immobilized to the electrodes in an example of the electrode array chip.

FIG. 5 is a conceptual diagram illustrating a case in which the electrodes are coupled with the subjects to be assayed in the example of the electrode array chip.

FIG. 6 is a diagram illustrating an example of an assay system using the electrode array chip.

FIG. 7 is a flow chart of an example of an assay method.

FIG. 8 is a diagram illustrating a case in which impedance of any electrode is arranged in time series.

FIG. 9A is a diagram illustrating another example of an assay system using the electrode array chip.

FIG. 9B is an enlarged view of an assay cell.

FIG. 10 is a flow chart of an assay method.

FIG. 11 is a diagram illustrating an example of the electrodes used in the electrode array chip.

FIG. 12 is a cross-sectional view illustrating an example of the electrodes used in the electrode array chip.

FIG. 13 is a conceptual diagram illustrating a case in which the antibodies as probes are immobilized to the electrodes in an example of the electrode array chip.

FIG. 14 is a conceptual diagram illustrating a case in which the electrodes are coupled with the subjects to be assayed in the example of the electrode array chip.

FIG. 15 is a diagram illustrating an example of the electrodes used in the electrode array chip.

FIG. 16 is a diagram illustrating an example of the electrodes used in the electrode array chip.

FIG. 17 is a diagram illustrating an example of the electrodes used in the electrode array chip.

FIG. 18 is a conceptual diagram illustrating a case in which the antibodies as probes are immobilized to the electrodes in an example of the electrode array chip.

FIG. 19 is a conceptual diagram illustrating a case in which the electrodes are coupled with the subjects to be assayed in the example of the electrode array chip.

FIG. 20A is a diagram illustrating the relationship between the electrode size and the impedance.

FIG. 20B is a diagram illustrating a change rate in impedance when the subjects to be assayed are coupled.

FIG. 21A is a diagram illustrating a difference in impedance due to the presence or absence of a sidewall in the vicinity of the electrode.

FIG. 21B is a diagram illustrating a difference of a change in impedance due to the presence or absence of a sidewall in the vicinity of the electrode.

FIG. 22A is a diagram illustrating a difference in impedance between a plate type electrode and a concave electrode.

FIG. 22B is a diagram illustrating a difference of a change in impedance between a plate type electrode and a concave electrode.

FIG. 23 is a circuit diagram.

FIG. 24 is a diagram illustrating the relationship between an absolute value of impedance and a frequency.

FIG. 25A is a diagram illustrating an example of the electrode array chip.

FIG. 25B is a diagram illustrating an example of the electrode array chip.

FIG. 26 is a diagram illustrating the relationship between a height of a sidewall provided in the vicinity of the electrode and a change rate of impedance.

FIG. 27A is a diagram illustrating the relationship between the electrode size and the impedance.

FIG. 27B is a diagram illustrating the relationship between the electrode size and a resistance component of a solution.

FIG. 28A is a diagram illustrating a state in which beads are present on the electrodes.

FIG. 28B is a diagram illustrating a state in which beads are not present on the electrodes.

FIG. 28C is a diagram illustrating a difference in impedance due to the presence or absence of the beads on the electrodes.

FIG. 29 is a diagram illustrating an example of the electrodes used in the electrode array chip.

FIG. 30 is a diagram illustrating an example of the electrodes used in the electrode array chip.

FIG. 31 is a diagram illustrating an example of the electrodes used in the electrode array chip.

FIG. 32A is a cross-sectional view illustrating an example of the electrodes used in the electrode array chip.

FIG. 32B is a plan view illustrating an example of the electrodes used in the electrode array chip.

FIG. 33A is a cross-sectional view illustrating an example of the electrodes used in the electrode array chip.

FIG. 33B is a plan view illustrating an example of the electrodes used in the electrode array chip.

FIG. 34A is a cross-sectional view illustrating an example of the electrodes used in the electrode array chip.

FIG. 34B is a plan view illustrating an example of the electrodes used in the electrode array chip.

FIG. 35A is a cross-sectional view illustrating an example of the electrodes used in the electrode array chip.

FIG. 35B is a plan view illustrating an example of the electrodes used in the electrode array chip.

FIG. 36A is a cross-sectional view illustrating an example of the electrodes used in the electrode array chip.

FIG. 36B is a plan view illustrating an example of the electrodes used in the electrode array chip.

FIG. 37A is a diagram illustrating the difference in impedance.

FIG. 37B is a diagram illustrating the change in impedance due to the coupling of the subjects to be assayed.

FIG. 38A is a diagram illustrating the difference in impedance.

FIG. 38B is a diagram illustrating the change in impedance due to the coupling of the subjects to be assayed.

FIG. 39A is a diagram illustrating an example of the electrodes used in the electrode array chip.

FIG. 39B is a diagram illustrating an example of the electrodes used in the electrode array chip.

FIG. 39C is a diagram illustrating an example of the electrodes used in the electrode array chip.

FIG. 40 is a diagram illustrating an example of the electrode array chip.

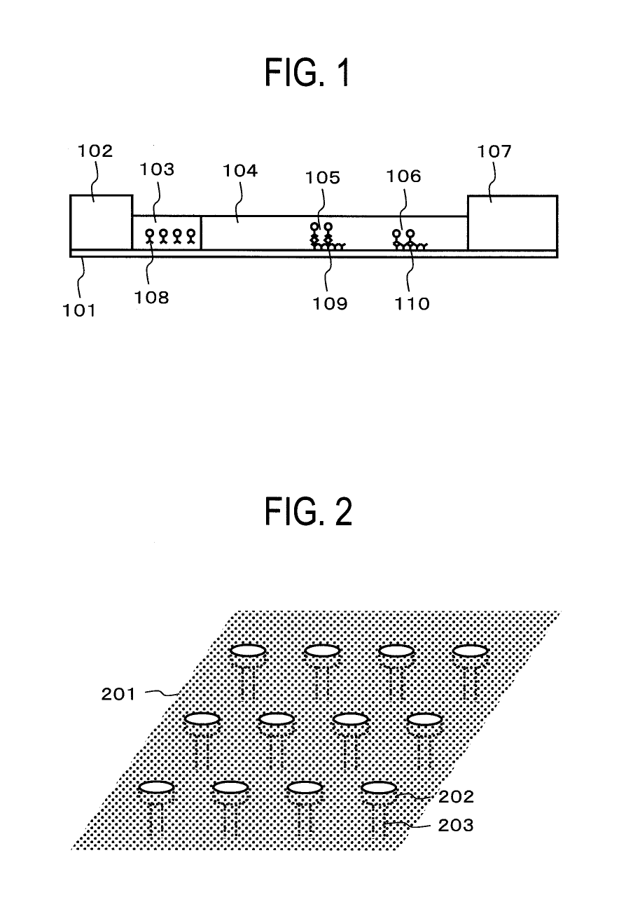

### DESCRIPTION OF EMBODIMENTS

Hereinafter, embodiments of the present invention will be described with reference to the accompanying drawings.

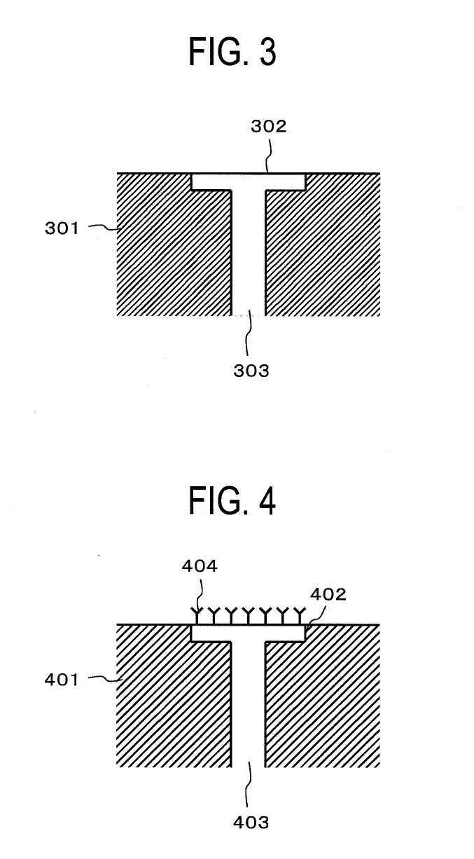

FIGS. 2 to 5 are diagrams illustrating an example of an electrode array chip according to the present invention. FIG. 2 is a bird's eye view of a part of the electrode array chip. Multiple electrodes 202 are disposed on a substrate 201, and each electrode 202 is connected with wirings 203. As illustrated in FIG. 2, it is preferable to bury the electrodes into the substrate since the coupling of the subjects to be assayed is less hindered. FIG. 3 shows a cross-sectional view of the electrodes of FIG. 2. Multiple electrodes 302 are disposed on a substrate 301, and each electrode 302 is connected with wirings 303.

FIG. 4 shows a conceptual diagram illustrating a case in which the antibodies as the probes are immobilized to the electrodes of FIG. 3.

Multiple electrodes 402 are disposed on a substrate 401, and each electrode 402 is connected with wirings 403 and a surface of the electrodes 402 is immobilized with antibodies 404. The probes may be the antibodies and when the subject to be assayed is a virus, may be a virus recognizing part. In addition, the same type of probes may be mounted on the multiple electrodes, but according to assay conditions, different types of probes may be mounted on the electrodes by deciding or mixing areas.

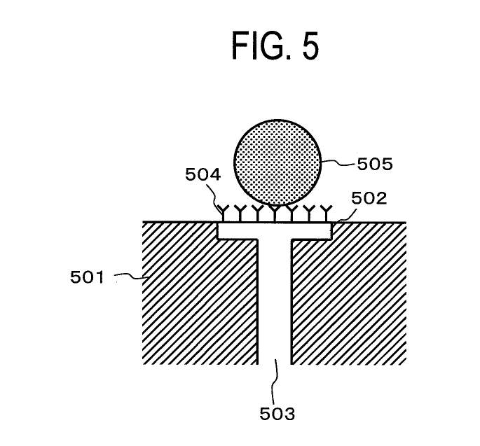

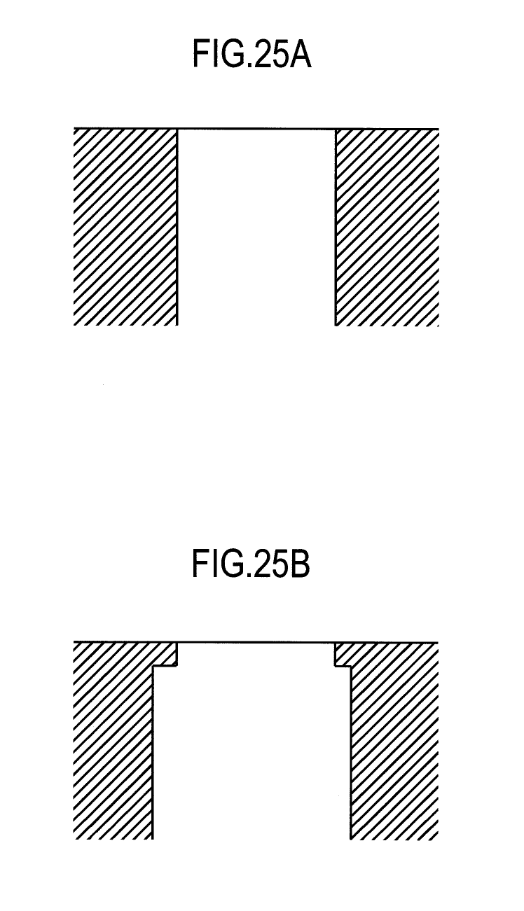

FIG. 5 is a conceptual diagram illustrating a case in which the subjects to be assayed are coupled with the electrodes to which the antibodies as the probes of FIG. 4 are immobilized. Multiple electrodes 502 are disposed on a substrate 501, and each electrode 502 is connected with wirings 503 and a surface of the electrodes 502 is immobilized with antibodies 504 and the antibodies 504 are coupled with one subject 505 to be assayed. In the substrate, insulating substances such as SiO₂, Si₃N₄, and the like, are used. In the electrodes, precious metals, such as gold, platinum, silver, copper, and the like, or carbon may be preferably used, but titanium, aluminum, chromium, and the like, may also be used according to required durability. In the wiring, a conductor is used. Instead of the antibody, a receptor may also be used according to the subject to be assayed. The connection between the electrodes and the wirings may be made by forming the wirings and then, forming the electrodes using, for example, a semiconductor manufacturing process. Further, as illustrated in FIG. 2, the wiring need not to be thinner than the electrode. For example, a diameter of the electrode may be the same as that of the wiring (FIG. 25A) or a diameter of the wiring may be thicker than that of the electrode (FIG. 25B) and when portions exposed on the surface of the substrate have the same shape, effects of the present invention can be obtained. As the size of the electrode, it is possible to prevent at least two subjects to be assayed from being coupled with the electrodes by setting the diameter of the electrode to be about twice or smaller than that of the subject to be assayed. Meanwhile, the change in impedance occurring when substances smaller than the subjects to be assayed are non-specifically coupled with each other is small and selectivity of the subject to be assayed is improved, by setting the diameter of the electrode to be ½ or more of that of the subject to be assayed.

An example of the subjects to be assayed may include cells, bacteria, viruses, and the like. An approximate size of the cells, bacteria, and viruses is shown in Table 1.

TABLE 1

| Subject to be assayed | Size | |
|---|---|---|
| Cell | 10 | μm |
| Bacteria | 0.3 to 8.0 | μm |
| Virus | 10 to 100 | nm |

Therefore, the diameter of the electrode may be about 5 to 20 μm in the case of a cell, about 0.15 to 16.0 μm in the case of bacteria, and 5 to 200 nm in the case of a virus, according to the subjects to be assayed.

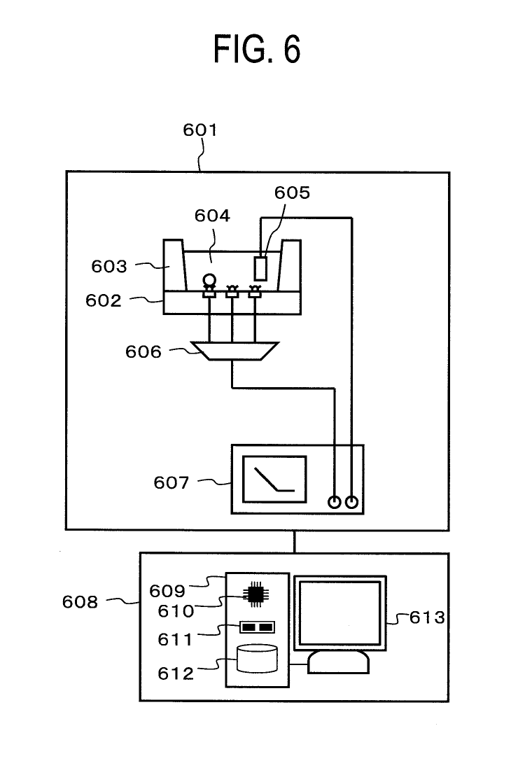

FIG. 6 is a conceptual diagram of an assay system using the electrode array chip according to the present invention. The present assay system includes an assay unit 601 and a control unit 608. An assay solution 604 is put in a container 603 formed on an electrode array chip 602. A counter electrode 605 is disposed in the assay solution 604. Each electrode of the electrode array chip 602 is connected with input terminals of a multiplexer 606. Output terminals of the counter electrode 605 and the multiplexer 606 are connected with an impedance assaying device 607. A role of the multiplexer 606 is to connect one of the multiple electrodes on the electrode array chip 602 with the impedance assaying device 607. A role of the impedance assaying device 607 is to assay the impedance between one of the multiple electrodes on the electrode array chip 602 and the counter electrode 605. As the control unit 608, for example, a personal computer (PC) illustrated in FIG. 6 may be used. The PC includes a data processing device 609 and a data display device 613 and the data processing device 609 includes, for example, an arithmetic unit 610, and a temporary memory 611, and a nonvolatile memory 612.

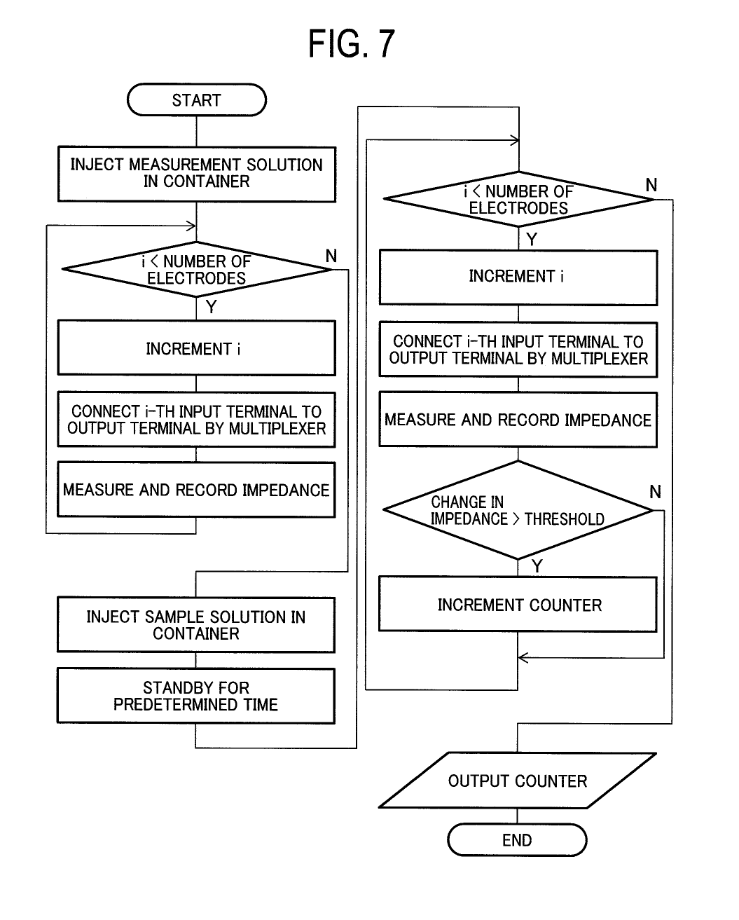

FIG. 7 shows an example of a flow chart of an assay method using an assay system according to the present invention. The example will be described together with FIG. 6. First, the assay solution 604 is injected in the container 603. Next, the impedance is assayed by the impedance assaying device 607 and each impedance is recorded, while switching the connection of the input terminal and the output terminal by the multiplexer 605. Therefore, the impedance between all the electrodes on the electrode array chip 602 and the counter electrodes is assayed. Next, a sample solution is injected into a container. A predetermined time waits until the subjects to be assayed in the sample solution are coupled with immobilized antibodies on the electrodes of the electrode array chip 602. Next, the impedance is assayed by the impedance assaying device 607 and each impedance is recorded, while switching the connection of the input terminal and the output terminal by the multiplexer 605. The impedance is compared with the impedance assayed before the sample solution is injected and when the change in impedance is larger than a threshold value, the counter is increased. Therefore, it is decided whether the subjects to be assayed are coupled with each electrode on the electrode array chip 602 and the number of subjects to be assayed coupled with all the electrodes on the electrode array chip 602 is counted. Finally, the values of the counter, that is, the number of subjects to be assayed coupled with all the electrodes on the electrode array chip 602 is output.

The assay precision can be more improved than the method of the related art that assays the quantity of subjects to be assayed using one electrode by counting the subjects to be assayed on the electrode using the threshold value. As factors changing the impedance, there are disturbances such as the non-specific adsorption of impurities, the change in solution salt concentration, the change in temperature, and the like, in addition to the coupling of the subjects to be assayed. In the method of the related art that assays the quantity of subjects to be assayed using one electrode, these disturbances degrade the assay precision, but when the subjects to be assayed on the electrode are counted using a threshold value, the disturbances do not affect the count values when the disturbances are smaller than the threshold value. Therefore, the effect of the disturbances is suppressed by counting the subjects to be assayed on the electrode using the threshold value to improve the assay precision.

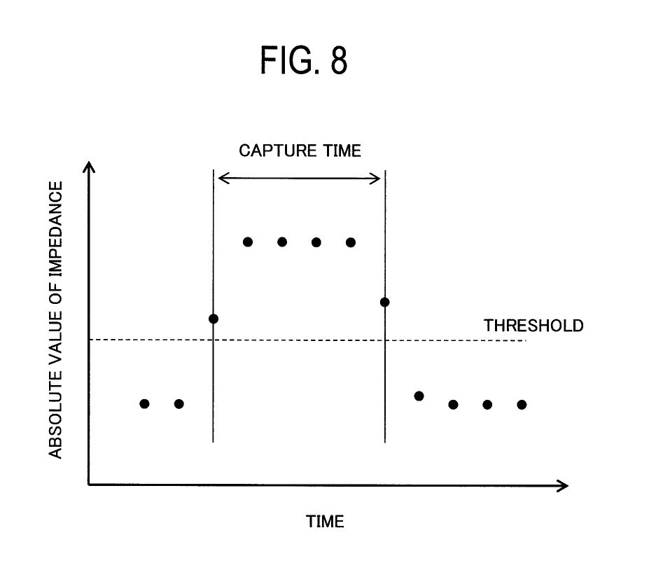

In the above example, it is decided whether the subjects to be assayed on the electrode is present using the threshold value, but the subjects to be assayed can be assayed with high precision by using the time-series change. For example, as illustrated in FIG. 8, it is possible to obtain the time when the substance are captured on the electrode by arranging the impedance of any electrode in parallel in time series. It is possible to improve the precision of decision by deciding whether the captured substance is the subjects to be assayed or the impurities from the time when the substance is captured on the electrode. Since the antibodies provided on the electrodes, and the like, specifically couples the subjects to be assayed, the time when the subjects to be assayed are coupled are longer than the case in which the impurities are infrequently coupled.

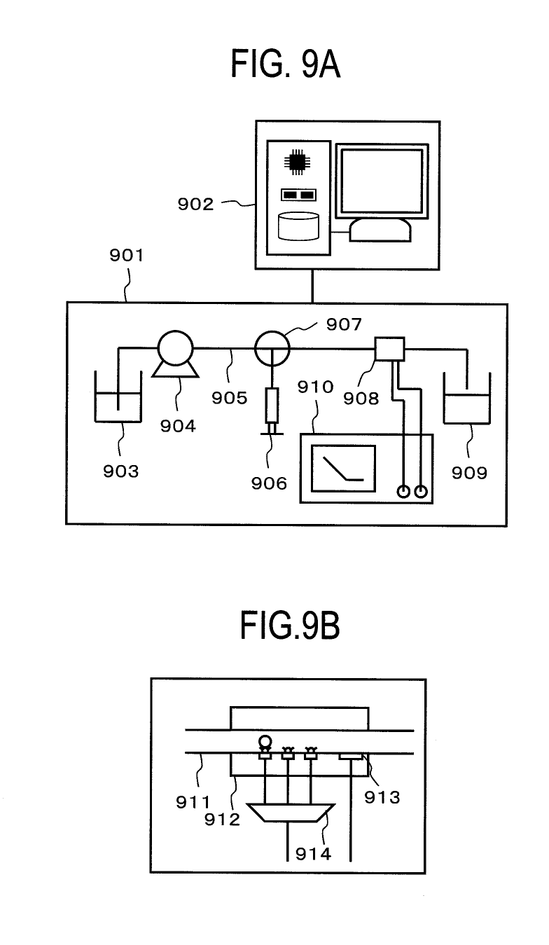

FIG. 9A is a conceptual diagram of a separate assay system using the electrode array chip according to the present invention. The present assay system includes an assay unit 901 and a control unit 902. In the assay unit 901, the assay solution within an assay container 903 passes through a channel 905 by a pump 904 and reaches a waste liquid container 909 via an assay cell 908. A valve 907 is present on the channel 905 and a specimen is injected into the assay solution in a channel by a specimen syringe 906. FIG. 9B is an enlarged view of the assay cell 908 and illustrates the case in which a channel 911 is in contact with an electrode array chip 912. Each electrode on the electrode array chip 912 is connected with an input terminal of a multiplexer 914. In addition, in this example, a counter electrode 913 is also mounted on the electrode array chip 912. Likewise, the counter electrode 913 is in contact with the channel 911. The output terminal of the multiplexer 914 and the counter electrode 913 are connected with an impedance assaying device 910. A role of the multiplexer 914 is to connect one of the multiple electrodes on the electrode array chip 912 with the impedance assaying device 910. A role of the impedance assaying device 910 is to assay the impedance between one of the multiple electrodes on the electrode array chip 912 and the counter electrode 913.

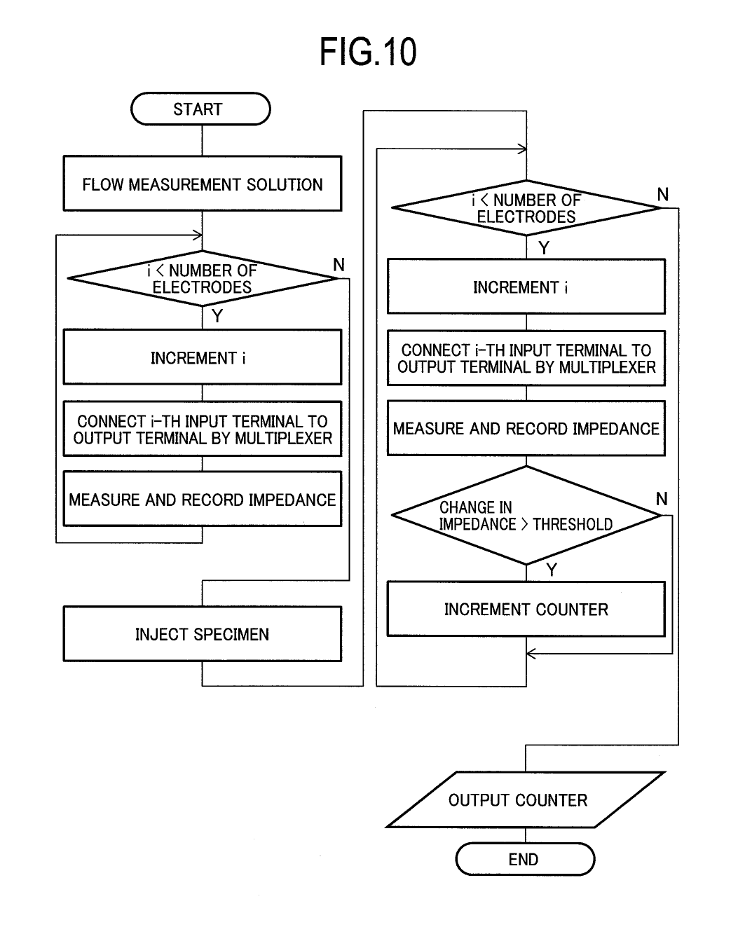

FIG. 10 is an example of a flow chart of an assay method using an assay system according to the present invention. The example will be described together with FIGS. 9A and 9B. First, the assay solution flows in the assay solution container 903 in the channel 905 using the pump 904. Next, the impedance is assayed by the impedance assaying device 910 and each impedance is recorded, while switching the connection of the input terminal and the output terminal by the multiplexer 914. Therefore, the impedance between all the electrodes on the electrode array chip 912 and the counter electrodes 913 is assayed. Next, the specimen is injected into the channel 905 and reacts within the assay cell 908. Next, the impedance is assayed by the impedance assaying device 910 and each impedance is recorded, while switching the connection of the input terminal and the output terminal by the multiplexer 914. The impedance is compared with the impedance assayed before the sample solution is injected and when the change in impedance is larger than a threshold value, the counter is increased. Therefore, it is decided whether the subjects to be assayed are coupled with each electrode on the electrode array chip 912 and the number of subjects to be assayed coupled with all the electrodes on the electrode array chip 912 is counted. Finally, the values of the counter, that is, the number of subjects to be assayed coupled with all the electrodes on the electrode array chip 912 is output.

In the above example, the impedances of the multiple electrodes on the electrode array chip is assayed one by one using the multiplexer, but the impedances of the plurality of electrodes may be simultaneously assayed by preparing the plurality of impedance assay devices. In addition, a circuit corresponding to the impedance assay device may be mounted in the electrode array chip.

In the assay flow of FIGS. 7 and 10, the quantity of assay solution put in the solution, the quantity of sample solution, the quantity of sent assay solution, and the quantity of specimen is preferably set to be a predetermined quantity. As a result, it is possible to compare the concentrations of the subject to be assayed between the plurality of sample solutions and the specimens or obtain an absolute value of the concentration of the subjects to be assayed. In addition, when the concentration of the subject to be assayed in the sample solution or the specimen is high, there is the case in which the subjects to be assayed are coupled mostly with all the electrodes. In this case, since the concentration cannot be correctly estimated, the concentration is assayed again by reducing the sample solution quantity, reducing the quantity of sent specimen, or diluting the sample solution or the specimen.

As another assay order, competition reaction may also be used. A bead or a liposome having approximately the same size as the subject to be assayed is prepared and a portion which is coupled with the probe immobilized on the electrode is prepared in the bead or the liposome. The assay is performed by mixing the subject to be assayed with the bead or the liposome and in the foregoing order. Since any one of the subject to be assayed and the bead or the liposome may be coupled with one electrode, when the quantity of subjects to be assayed is small, the bead or the liposome is coupled with a large number of electrodes, but when the quantity of subjects to be assayed is large, the number of electrodes coupled with the subjects to be assayed is increased and the number of electrodes coupled with the bead or the liposome is decreased accordingly. That is, the number of electrodes coupled with the bead or liposome is increased and decreased according to the quantity of subjects to be assayed. Therefore, the electrodes that are not coupled with anything, the electrodes that are coupled with the subjects to be assayed, and the electrodes that are coupled with the bead or the liposome are decided from the change in impedance and the subjects to be assayed may be quantified by comparing the number of the electrodes coupled with the subjects to be assayed and the number of the electrodes coupled with the bead or the liposome.

When assaying protein, and the like, the bead or the liposome may also be used as a mark. The probe immobilized on the electrode and the probe immobilized to the bead or the liposome are coupled via the subject to be assayed. As the probe, the antibody, and the like, is used. As a result, it is possible to assay a substance smaller than the electrode. Unlike the case of assaying the substance having the same size as the electrode, the subjects to be assayed cannot be counted from one, but since the non-specific adsorption of the mark is suppressed or the mark isolated in the solution is not detected as a signal, there is an advantage in that the homogeneous analysis can be performed.

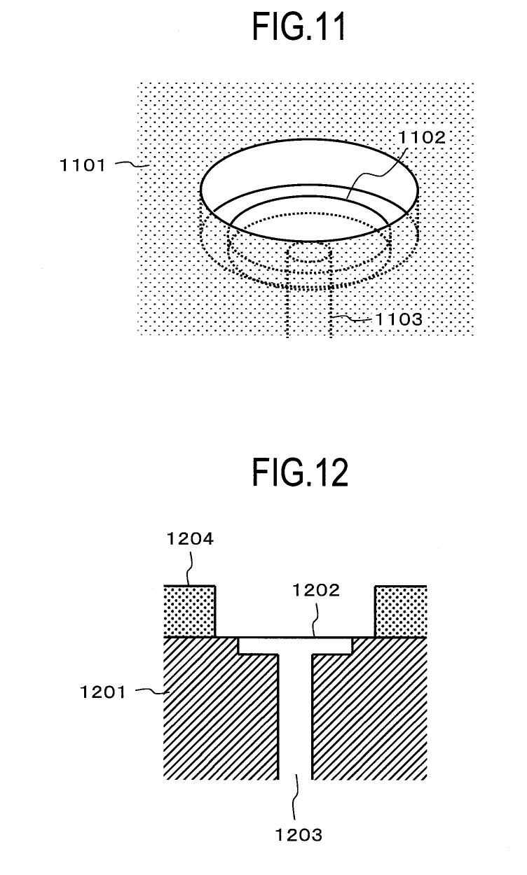

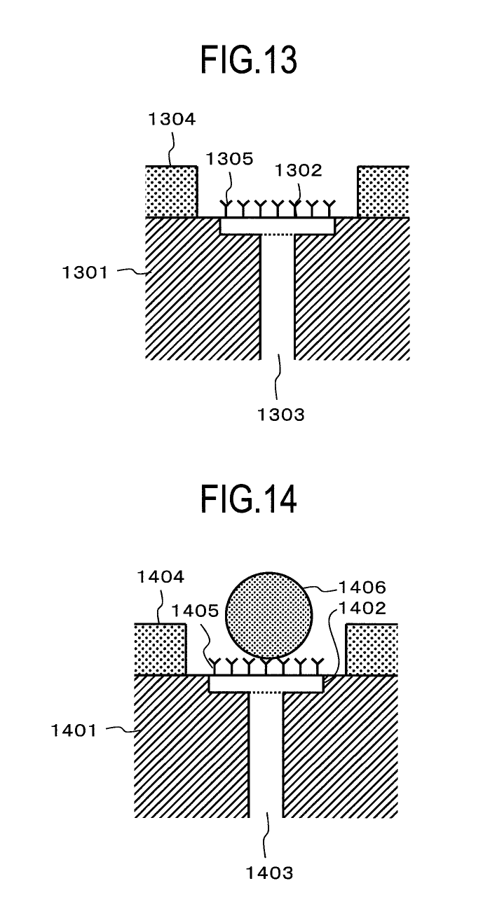

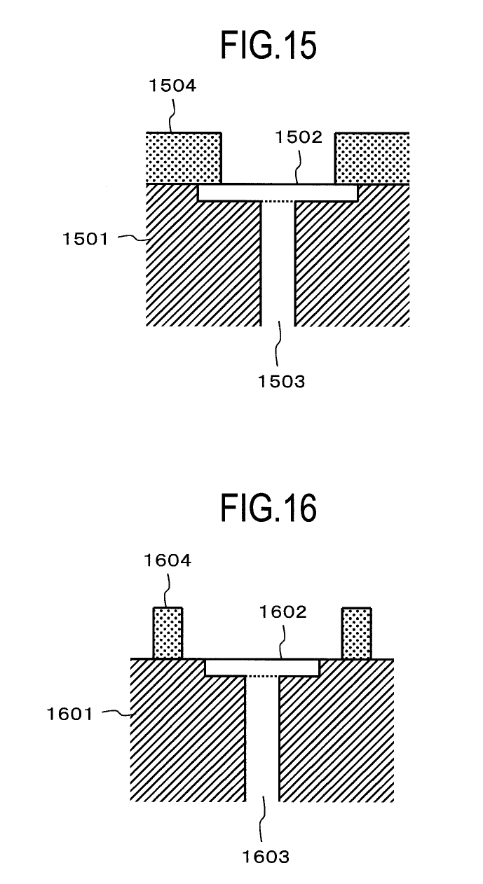

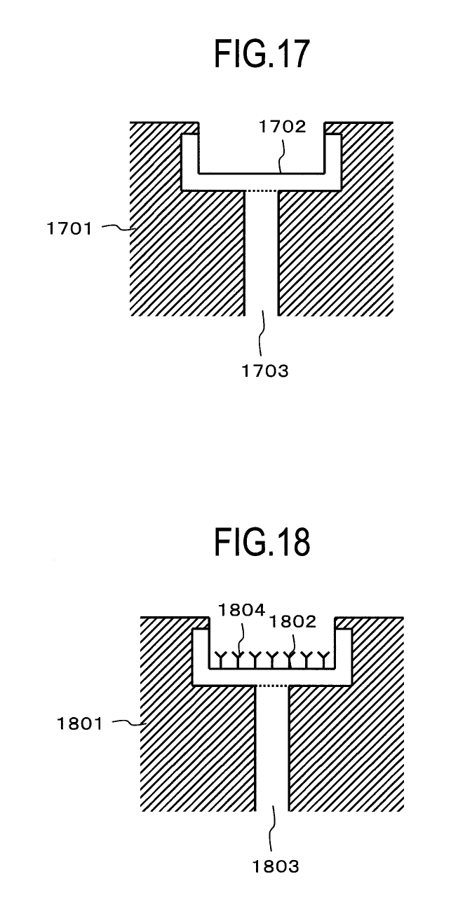

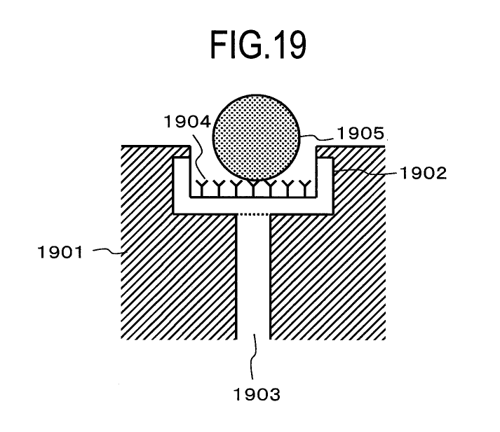

FIGS. 11 to 19 are diagrams illustrating another example of the electrodes that are included in the electrode array chip according to the present invention. FIG. 11 is a bird's eye view and FIG. 12 is a cross-sectional view thereof. A substrate 1101 is provided with a portion that is dug down once and a bottom portion of the dug portion is provided with an electrode 1102. The electrode 1103 is connected with a wiring 1103. When being viewed from another aspect, an electrode 1202 is buried into the substrate 1201, the electrode 1202 is connected with a wiring 1203, and a sidewall 1204 is present in the vicinity of the electrode 1202. FIG. 13 illustrates a state in which an antibody is immobilized to the electrode of FIG. 12 and FIG. 14 illustrates a state in which the subject to be assayed is coupled with the antibody of FIG. 13. FIG. 15 illustrates a shape in which a part of the sidewall is protruded on the electrode. As such, when the sidewall is protruded on the electrode, in the present embodiment, an exposed portion of the electrode is considered as an effective electrode. For this reason, it is possible to control the effective size of the electrode with a size of an opening part of the sidewall and share a part of a manufacturing process without making the overall size of the electrode small. In addition, this is effective even in the case in which it is difficult to make the overall size of the electrode small. FIG. 16 illustrates a shape in which the sidewall is present only in the vicinity of the electrode. FIG. 17 illustrates an example of a shape in which the electrode is a concave shape. FIG. 18 illustrates a state in which the antibody is immobilized to the concave electrode of FIG. 17. FIG. 19 illustrates the state in which the subject to be assayed is coupled with the antibody of FIG. 18. Here, when an inner diameter of the sidewall is two times or smaller of the subject to be assayed, it is possible to secure that only one subject to be assayed is coupled with the antibody.

Hereinafter, the effect of the case in which each configuration is taken will be described with reference to data.

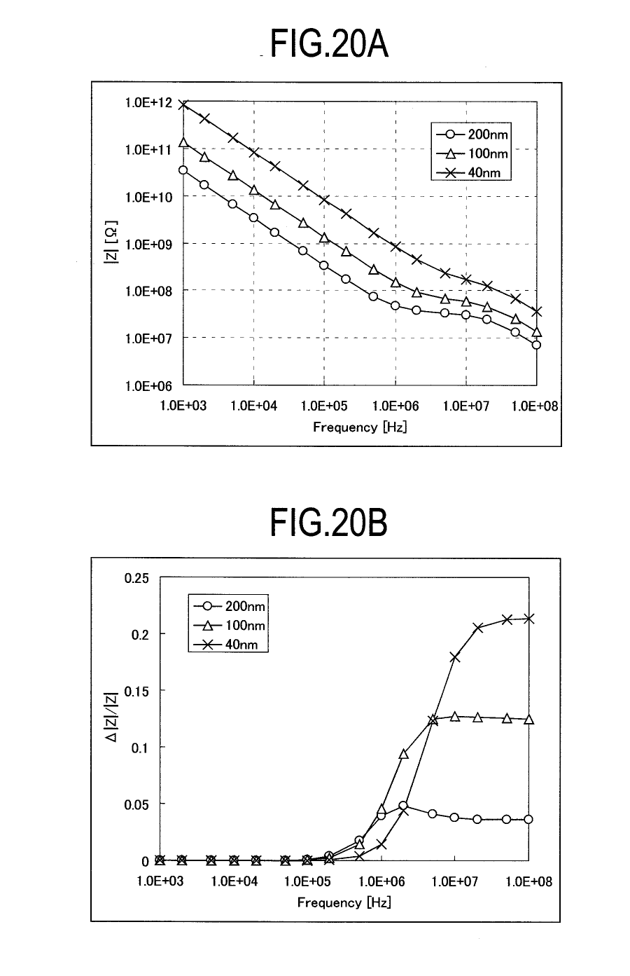

FIGS. 20A and 20B illustrate the relationship between the size and impedance of the electrode. FIG. 20A illustrates results obtained by numerically analyzing the relationship of the absolute value between frequency and impedance when in the electrode having the shape as illustrated in FIG. 3, the electrode has a disc shape having a diameter of 40, 100, and 200 nm based on a finite element method. FIG. 20B illustrates results obtained by numerically analyzing the change rate in impedance when changing from the state of FIG. 4 to the state of FIG. 5 based on the finite element method. The electrode has a disc shape having a diameter of 40, 100, and 200 nm, the subject to be assayed is to be a spherical body of 100 nm and an interval between the electrode and the subject to be assayed (for example, a length of the antibody 404 as illustrated in FIG. 4) is set to be 10 nm. An electric double layer formed on the surface of the electrode has a resistance value of 4 Ωm² and a capacitance of 15 μF/cm², an assay solution has a resistance value of 0.1 Ωm and relative permittivity of 80, the subject to be assayed has a thickness of an outer film of 10 nm, a resistance value of 10⁸ Ωm, and relative permittivity of 1, and an internal liquid has a resistance value of 1 Ωm and relative permittivity of 80. When varying parameters, the electrode largely depends on the resistance value and the relative permittivity of the assay solution and the capacitance of the electric double layer, but does not largely depend on other parameters, and there is no great change in the obtained results even on the assumption that the subject to be assayed is a sphere of an insulator. As illustrated in FIG. 20B, a maximum value of the change rate of impedance is in inverse proportion to the diameter of the electrode, while the frequency at which the change in impedance starts is also in inverse proportion to the diameter of the electrode. Further, as illustrated in FIG. 20A, the absolute value of impedance is increased in inverse proportion to the diameter of the electrode. That is, it is possible to expect the improvement in assay precision since the change rate of impedance is increased at the electrode having a smaller size, but it may be difficult to perform the assay due to the increase in frequency used for assay or the increase in absolute value of impedance at one side.

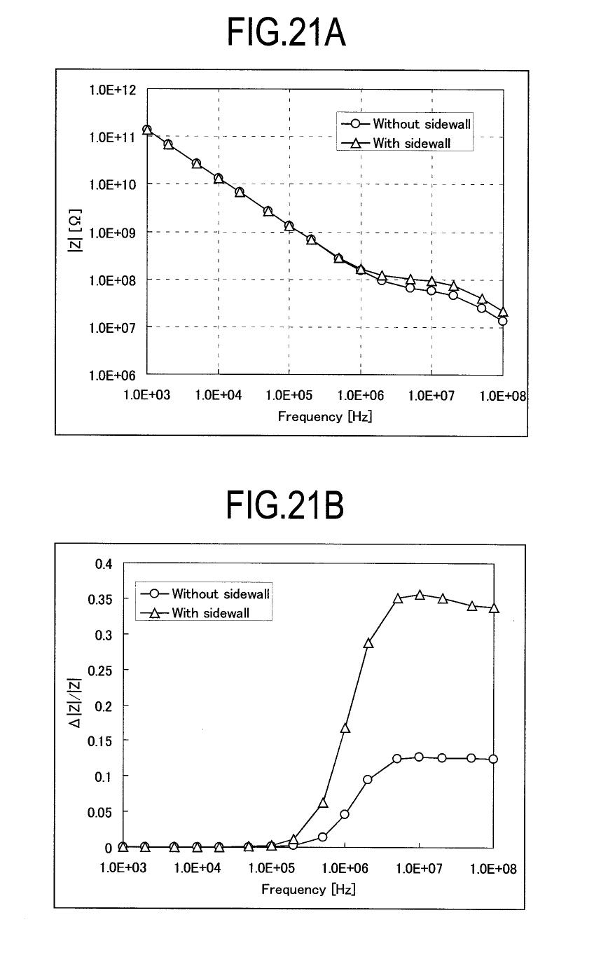

FIGS. 21A and 21B illustrate the difference in impedance in the case of with a sidewall in the vicinity of the electrode or in the case of without a sidewall in the vicinity of the electrode and when the electrode having the shape as illustrated in FIG. 3 as the case of without a sidewall has a disc shape having a diameter of 100 nm and when the electrode having the shape as illustrated FIG. 12 as the case of with a sidewall has a disc shape having a diameter of 100 nm, in which an inner diameter of the sidewall is set to be a diameter of 140 nm and a height thereof is set to be 70 nm, the absolute value of impedance (FIG. 21A) and the change in impedance (FIG. 21B) due to the coupling of the subjects to be assayed that is a spherical body having a diameter of 100 nm are obtained by a numerical analysis manner based on the finite element method. The sidewall has a resistance value of 10⁸ Ωm and relative permittivity of 1. The change rate of impedance is increased three times or more due to the presence of the sidewall. It is considered that the reason is that quantitatively, an effect of current pass present in a gap between the electrode and the subject to be assayed which is generated due to the subject to be assayed that is a spherical body is suppressed due to the presence of the sidewall and this is an effect obtained when the subject to be assayed is not flat like cells in an adhesion state or is a spherical shape like cells, bacteria, or viruses that are not adhered. The reason is that when the subject to be assayed is flat, the gap between the electrode and the subject to be assayed is hardly generated or when the gap is uniform but the subject to be assayed is a spherical shape, the generation of the gap between the flat electrode and the subject to be assayed cannot be avoided. As such, it is possible to increase the change in AC impedance due to the presence of the subject to be assayed in the vicinity of the electrode by preparing the sidewalls in the vicinity of each electrode.

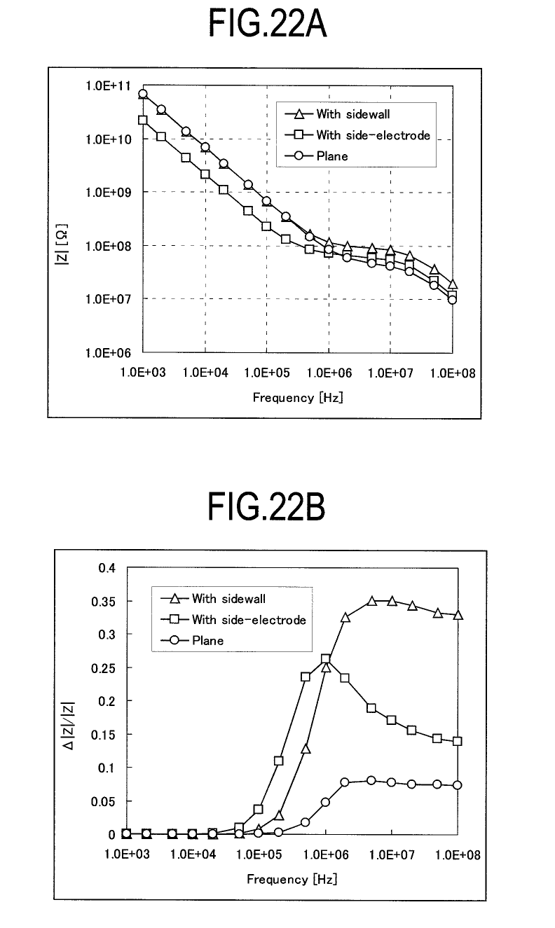

FIGS. 22A and 22B illustrate the difference in impedance between a plate type electrode and a concave electrode in the case of with a sidewall in the vicinity of the plate type electrode and when the electrode having a shape as illustrated FIG. 3 as the plate type electrode has a disc shape having a diameter of 140 nm, when in the electrode having the shape as illustrated in FIG. 12 as the case with a sidewall in the vicinity of the plate-type electrode, a diameter is set to be 140 nm and an inner diameter of a sidewall is set to have a diameter of 140 nm, and when in the electrode having the shape as illustrated in FIG. 17 as a concave electrode, a diameter is set to be 140 nm and a depth is set to be 70 nm, the absolution value of impedance (FIG. 22A) and the change in impedance (FIG. 22B) due to the coupling of the subjects to be assayed that is a spherical body of a diameter of 100 nm are obtained by a numerical analysis manner based on the finite element method. Plane represents the plate type electrode, with side-electrode represents the concave electrode, and with sidewall represents the case in which the sidewall is present in the vicinity of the plate type electrode. The maximum value of the change rate of impedance is three times or larger in the concave electrode as compared with the plate type electrode and is four times or larger when the sidewall is present in the vicinity of the plate-type electrode. Further, the frequency at which the change rate of impedance is maximal is little changed in the case of the plate type electrode and when the sidewall is present in the vicinity of the plate type electrode, but is reduced to ⅕ in the concave electrode as compared with the plate type electrode. From this, the change in AC impedance is increased due to the presence of the subjects to be assayed in the vicinity of the electrode and the frequency at which the subjects to be assayed can be detected may be shifted to a low frequency side, by making the shape of the electrode concave.

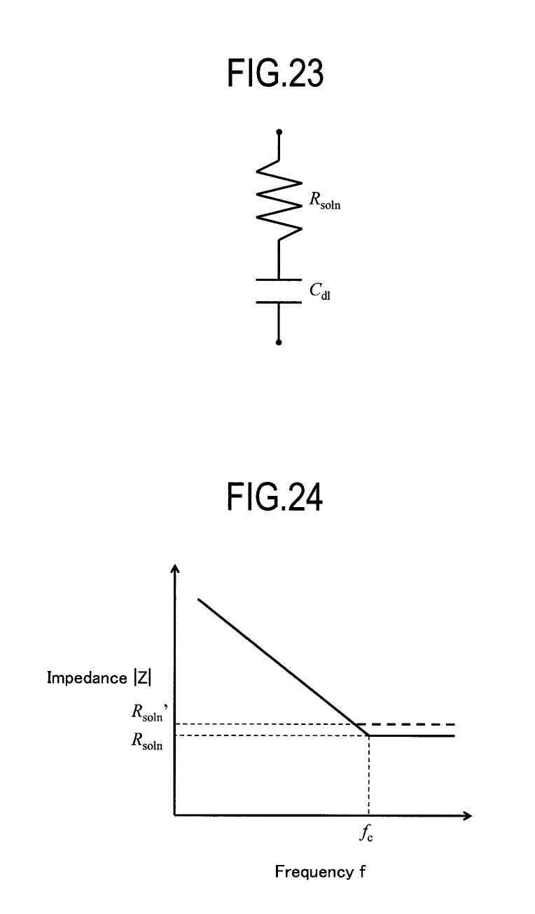

FIG. 23 is a circuit diagram for describing a phenomenon illustrated in FIGS. 20 to 22. The circuit is a serial circuit of Rₛₒₗₙ and C_{dl}, where Rₛₒₗₙ represents solution resistance and C_{d1} represents capacitance due to the electric double layer of the surface of the electrode. The impedance Z of the circuit is represented by the following Equation 1.

$$Z = {R}_{so l n} + j \frac{1}{2 π {C}_{dl}} \qquad [ Equation 1 ]$$

(j is an imaginary number) (Equation 1)

An absolute value (|Z|) may be plotted as illustrated in FIG. 24 with respect to a frequency (f). A frequency f_{c} is represented by the following Equation 2.

$$\begin{matrix}[ Equation 2 ] & \\ {f}_{c} = \frac{1}{2 π {R}_{so l n} {C}_{dl}} & ( Equation 2 )\end{matrix}$$

In f<f_{c},

$$\begin{matrix}[ Equation 3 ] & \\ \vert Z \vert = \frac{1}{2 π {C}_{dl}} & ( Equation 3 )\end{matrix}$$

In f>f_{c}, |Z| approximates as represented by the following Equation 4.

[Equation 4]

|Z|=Rₛₒₗₙ (Equation 4)

It can be appreciated that FIG. 24 approximately illustrates the shape of FIGS. 20A, 21A, and 22A.

In FIG. 20A, the frequency f_{c} is approximately in proportion to the diameter of the electrode and the Rₛₒₗₙ is approximately in inverse proportion to the diameter of the electrode. The reason why the Rₛₒₗₙ is approximately in inverse proportion to the diameter of the electrode is that the Rₛₒₗₙ is dominantly shown in the vicinity of the diameter of the electrode from the electrode due to the current density reduced in inverse proportion to a square of a distance from the electrode, which is shown as follows.

[Equation 5]

Rₛₒₗₙ∝(resistivity of solution)×(diameter of electrode)÷(area of electrode)∝1÷(diameter of electrode) (Equation 5)

Meanwhile, the capacitance is in proportion to the surface area of the electrode, and therefore the C_{dl} is in proportion to a square of the diameter of the electrode. Therefore, the frequency f_{c} is approximately in proportion to the diameter of the electrode according to the above Equations.

When the subject to be assayed is present in the vicinity of the electrode, the current pass is limited, such that the Rₛₒₗₙ is increased so as to be Rₛₒₗₙ′ and the impedance is changed (a dotted line in FIG. 24). In this case, the impedance is increased in the vicinity of f_{c} and at a frequency larger than f_{c}, but the change in impedance is small or almost disappears at a frequency smaller than f_{c}. The reason is that the capacitance of the electric double layer dominantly defines the impedance at the frequency smaller than f_{c}. Therefore, a frequency in the vicinity of f_{c} and a frequency larger than f_{c} are used to detect the subject to be assayed.

When considering the reproducibility of assay, the assay is easily affected by parasitic capacitance or wiring capacitance of a circuit when the assayed frequency is high, and therefore it is preferable that the assay is performed at low frequency, if possible. However, as described above, it is difficult to perform the assay at a frequency lower than f_{c}. Therefore, it is preferable to lower f_{c} as maximally as possible. As described above, the frequency f_{c} is approximately in proportion to the diameter of the electrode, and therefore it is preferable to make the electrode large, if possible. However, as illustrated in FIG. 20B, as the electrode is increased, the change rate of impedance becomes small due to the subject to be assayed in the vicinity of electrode. Therefore, in the plate type electrode, the frequency f_{c} and the change rate of impedance are in the trade-off relationship.

In the case of the electrode in which the side wall is prepared, as illustrated in FIGS. 11 to 16, as illustrated in FIGS. 21A and 21B, the frequency f_{c} is little changed due to the presence or absence of the sidewall, but the change rate of impedance is increased. The reason is that the Rₛₒₗₙ is insignificantly affected by the presence or absence of the sidewall but the Rₛₒₗₙ′-Rₛₒₗₙ can be increased, and this is a new structure capable of overcoming the trade-off relationship of the plate type electrode.

In the case of the concave electrode illustrated in FIGS. 17 to 19, as illustrated in FIGS. 22A and 22B, the Rₛₒₗₙ is insignificantly affected as compared with the plate type electrode, but the frequency f_{c} is reduced and the change rate of impedance is increased. It is considered that the reason is that when the plate type electrode is compared with the concave electrode, the area of the electrode is not changed in a projection of the electrode in a direction vertical to the substrate, and therefore, the Rₛₒₗₙ is insignificantly affected, but the concave electrode has a large surface area of the electrode, such that the concave electrode has the large C_{dl}, and as a result, the frequency f_{c} is reduced. It is considered that the increase in the change rate of impedance is the same effect as the case of the sidewall. The concave electrode is a new structure capable of overcoming the trade-off relationship of the plate type electrode.

The virus has a diameter of about 100 nm and the bacteria has a diameter of about 1 μm and in a sodium chloride solution of 100 mM, the frequency f_{c} of the electrode having each diameter is about 50 MHz and 5 MHz and the solution resistance is about 10 MΩ and 1 MΩ. That is, when the subjects to be assayed are assayed one by one, the effect of parasitic capacitance or wiring capacitance of the circuit may not be disregarded, and the frequency f_{c} is reduced and therefore, it is effective to make the effect of parasitic capacitance or wiring capacitance of the circuit small by reducing the frequency f_{c}.

As another effect of the sidewall or the concave electrode, it is possible to improve the selectivity of the subjects to be assayed. When the substances larger than the subjects to be assayed are non-specifically coupled with the surface of the electrode in the plate type electrode, it is likely to cause the same change in impedance as in the coupling of the subjects to be assayed. However, the substance larger than the diameter of the sidewall or the concave electrode cannot approach the surface of the electrode due to the presence of the sidewall or by making the electrode concave. As a result, the selectivity of the subject to be assayed is improved.

The frequency f_{c} may be reduced while reducing an effect on the Rₛₒₗₙ even by using a porous substance in the electrode. When the electrode is formed of the porous substance, the surface area of the electrode is increased and the C_{dl} is increased, but the area of the electrode is not changed in the projection of the electrode in the direction vertical to the substrate, and therefore the Rₛₒₗₙ is insignificantly affected. As a result, the frequency f_{c} is reduced. In addition, the diameter of the hole is larger than the thickness of the electric double layer and therefore is preferably about 1 nm or more. Further, the same effect can be obtained even by using the electrode having a high rough surface roughness.

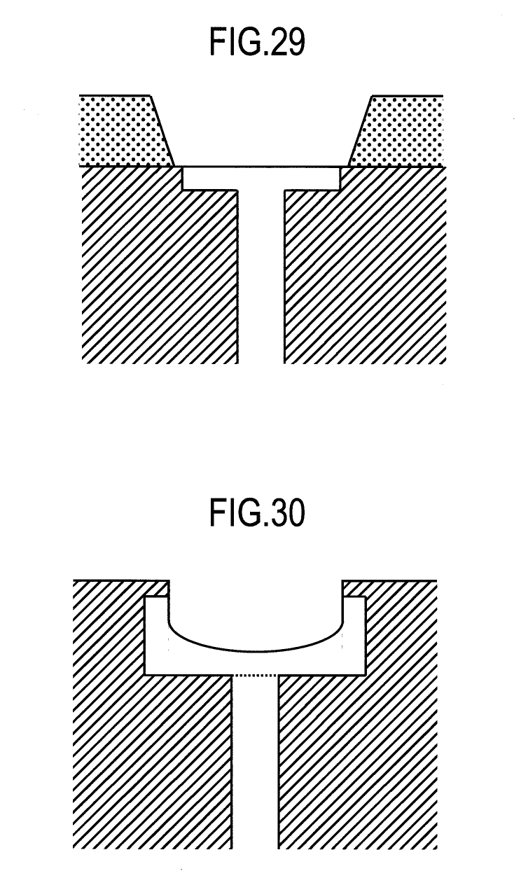

FIGS. 29, 30, and 31 have a shape different from FIGS. 12 and 17. Even though the sidewall has a tapered shape as illustrated in FIG. 29, the same effect of the sidewall as that obtained from the shape of FIG. 12 can be obtained. Even though the electrode is concaved and rounded as illustrated in FIG. 30, the same effect of the concave electrode as that obtained from the shape of FIG. 30 can be obtained. The effect is reduced even when the end of the concave electrode is exposed outside the hole as illustrated in FIG. 31, but the same effect of the concave electrode as that obtained from the shape of FIG. 30 can be obtained.

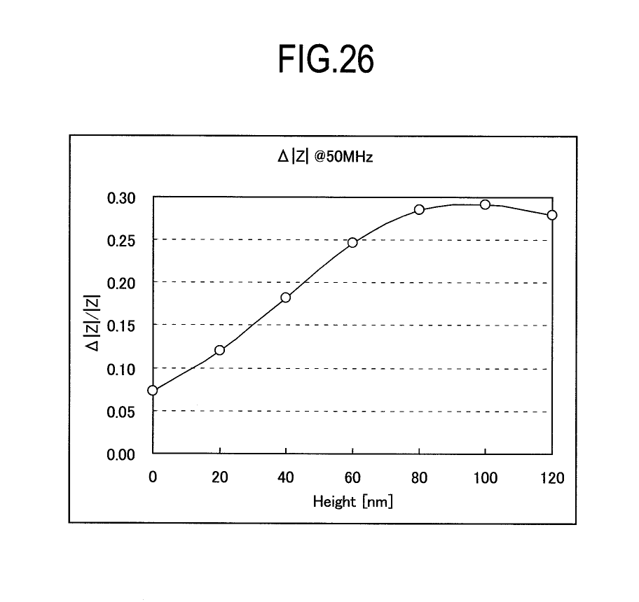

FIG. 26 illustrates the difference in the change rate of impedance when the height of the sidewall disposed in the vicinity the electrode is changed. In the electrode having the shape of FIG. 12, the change in impedance due to the coupling of the subject to be assayed that is the spherical body having a diameter of 100 nm in the disc-shaped electrode having a diameter of 100 nm and an inner diameter of a sidewall of 160 nm is obtained. The effect of the increase in the change rate of impedance is shown due to the sidewall from when the height of the sidewall is low (20 nm) and is shown up to about 100 nm that is a size of the subject to be assayed. Therefore, it can be appreciated that the change rate of impedance due to the sidewall is increased up to about the size of the subject to be assayed.

It is possible to detect a plurality of kinds of subjects to be assayed at one time by performing the detection of the subjects to be assayed using the electrode array chip having the electrode in which different antibodies are immobilized to one substrate. For example, it is possible to decide the influenza type in which a human subject is affected by assaying each of the number of viruses in a body fluid extracted from the subject which is suspected of the affection of the influenza by using the electrode array having 200 electrodes of a diameter of 100 nm to which an antibody for an A type influenza virus is immobilized and 200 electrodes of a diameter of 100 nm to which an antibody for a B type influenza virus is immobilized and, the array in which the electrode to which the antibody for the influenza virus (a plurality of types) is immobilized and the electrode to which the antibody for the bacteria is immobilized are mixed is used such that it is possible to decide the infection of bacteria while deciding the decision of the affection of the influenza and help a treatment for preventing a complication.

In addition, the subject to be assayed may also be bacteria. In this case, the electrode having a diameter of about 1 μm, that matches bacteria (cell) such as salmonella, vibrio parahaemolyticus, campylobacter, staphylococcus, colon bacillus, botulinus, bacillus cereus, clostridium perfringens, listeria monocytogenes, and the like, is used. In this case, the subject to be assayed may be oval, but the basic assay principle is unchanged.

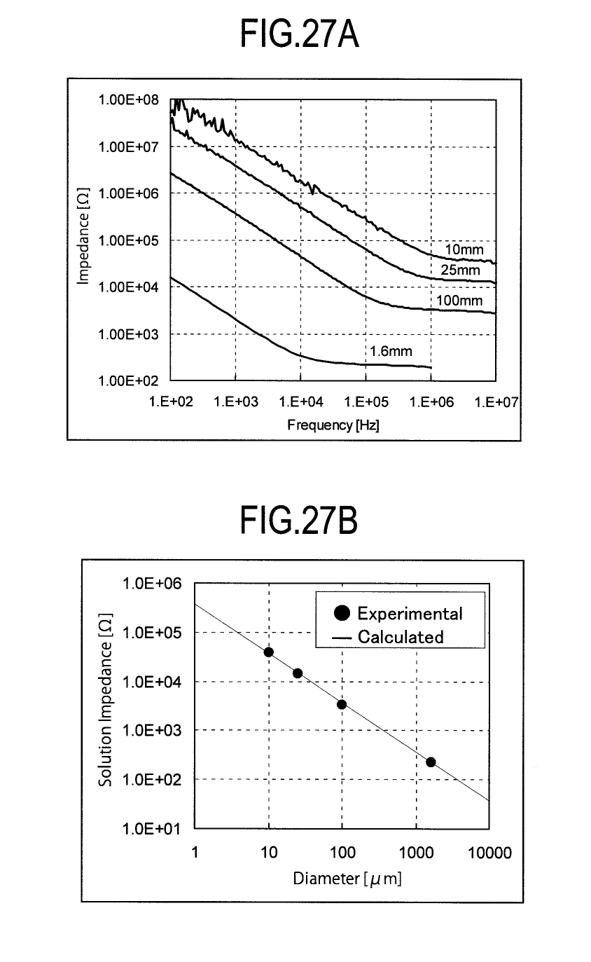

FIGS. 27A and 27B illustrate results of experimentally obtaining the relationship between the size and the impedance of the electrode. A gold electrode of which the diameter of an opening part is 10 μm, 25 μm, 100 μm, and 1.6 mm and a platinum line are disposed in a sodium sulfate solution 100 mM and the impedance between the gold electrode and the platinum line is assayed. In this case, the applied voltage has an amplitude of 10 mV. As a result, as illustrated in FIG. 27A, the absolute value of impedance is obtained. A straight line in which a low frequency side is inclined is due to capacitance component, mainly the electric double layer of the surface of the gold electrode and a straight line in which a high frequency side is flat is due to resistance component, mainly a solution in the vicinity of the gold electrode. The results of plotting the resistance component of the solution with respect to the diameter of the gold electrode are represented by a circle in FIG. 27B. It can be appreciated that the solution resistance is in inverse proportion to a diameter. The impedance is obtained by numerical analysis using the foregoing finite element method based on an assayed value 0.625 Ωm of resistance of sodium sulfate of 100 mM, such that the results are obtained as represented by a straight line of FIG. 27B. It can be appreciated that the experimental value coincides with the calculated value well and the numerical analysis based on the finite element method reproduces the actual assay well.

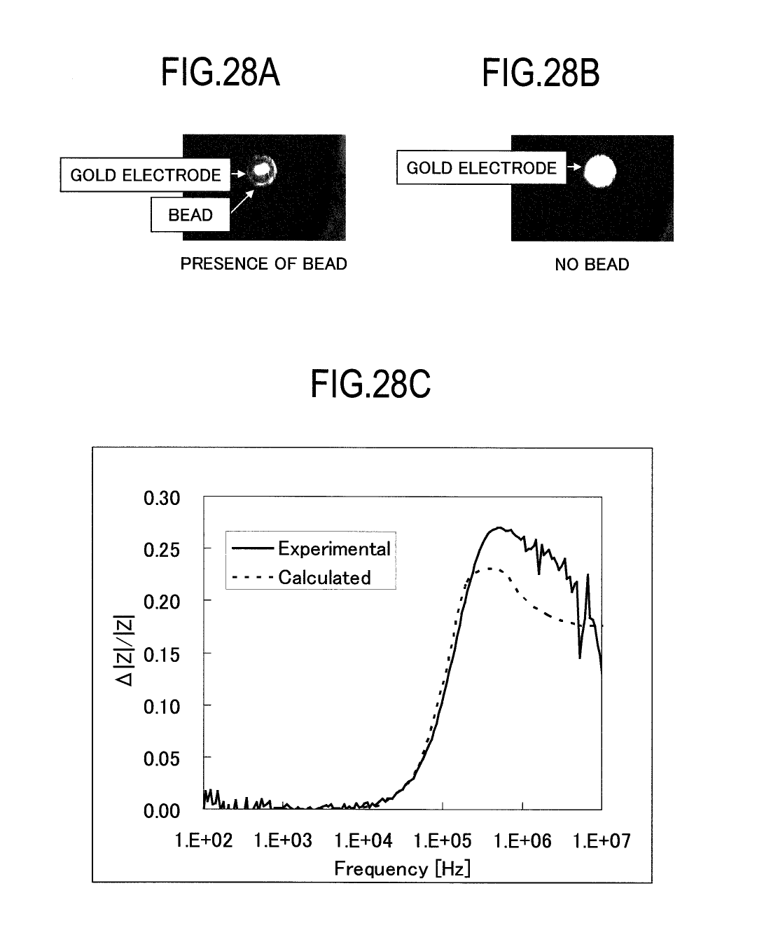

FIG. 28C shows results of detecting a bead having a diameter of 90 μm as the subject to be assayed using the gold electrode of the opening part having a diameter of 100 μm. The gold electrode of which the diameter of the opening part is 100 μm and the platinum line are disposed in a sodium sulfate solution of 100 mM and the impedance between the gold electrode and the platinum line is assayed. Simultaneously, an image is also acquired by an optical microscope. The change (change rate) in impedance is observed as represented by a solid line of FIG. 28C in the case of FIG. 28A in which the bead is present on the gold electrode and in the case of FIG. 28B in which the bead is not present on the gold electrode. The change in impedance is obtained by the numerical analysis using the foregoing finite element method based on the assayed value of resistance of the solution and the assayed value of capacitance of the gold electrode, such that the results as represented by a dotted line of FIG. 28C is obtained. It can be appreciated that both of the shape and the value can be reproduced well and the numerical analysis based on the finite element method reproduces the actual assay well.

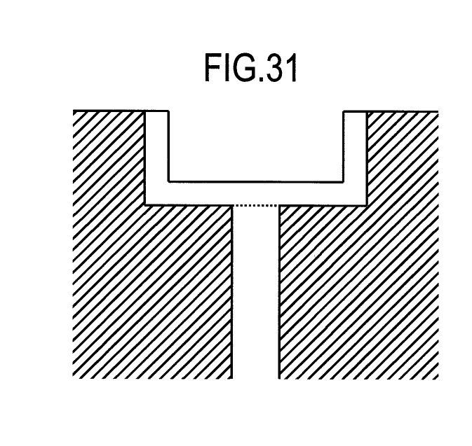

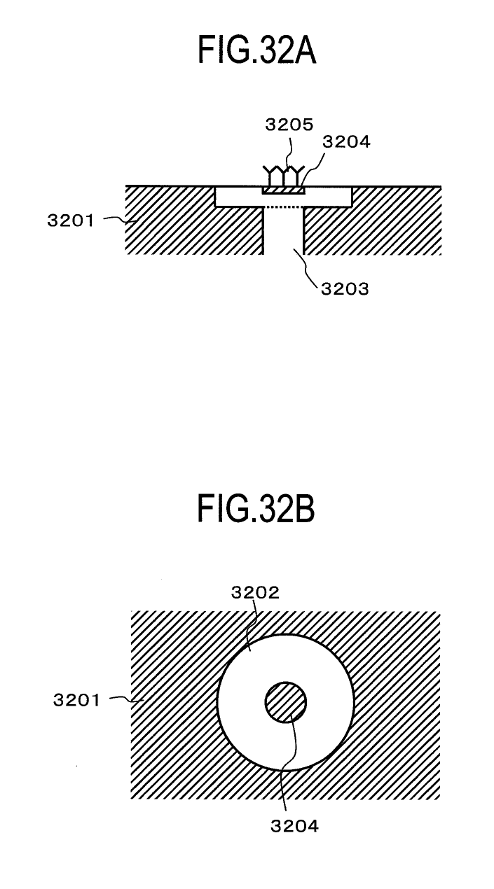

FIGS. 32A and 32B illustrate another example of the electrode that is included in the electrode array chip. FIG. 32A illustrates a cross-sectional view and FIG. 32B illustrates a plan view. Electrodes 3202 are disposed on a substrate 3201, and each electrode 3202 is connected with wirings 3203. An upper surface of the electrode 3202 has a donut shape and a central portion thereof is provided with an insulating portion 3204. An antibody 3205 is immobilized to the insulating portion.

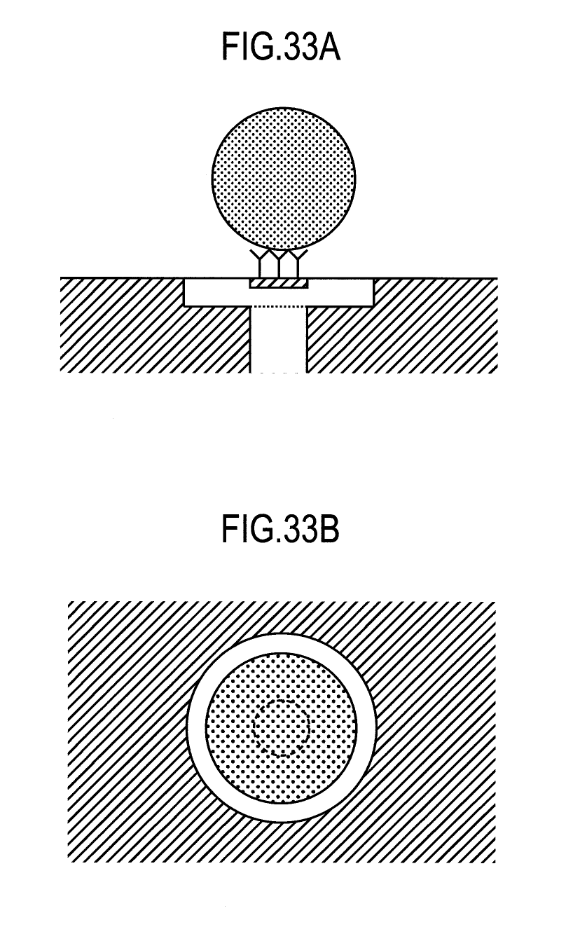

FIGS. 33A and 33B illustrate the state in which the subject to be assayed is coupled with the antibody 3205. In this way, a place where the subject to be assayed is coupled is limited to an electrode central portion and the reproducibility of the change in signal is increased when the subject to be assayed is coupled. As illustrated in FIGS. 32A and 32B, it is easy to immobilize the antibody only to the electrode central portion by disposing the insulating portion 3204. The reason is that the insulating portion 3204 may be formed of silicon oxide, silicon nitride, quartz, titanium oxide, and the like, and the antibody may be immobilized only to the insulating portion 3204 using compounds such as a silane coupling agent that is coupled with the insulating portion without being coupled with the metal portion or the antibody is immobilized to both the electrode 3202 and the insulating portion 3204 and then, voltage is applied to the electrode 3202, such that the antibody immobilized to the electrode 3202 can be removed or the antibody can be immobilized only to the insulating portion 3204 using the difference in physical properties between the electrode 3202 and the insulating portion 3204. In addition, since the antibody is not immobilized to the electrode, a degree of freedom in design of the electrode is increased. For example, when the antibody is immobilized to the overall surface of the electrode using alkanethiol, the electrode needs to be formed of precious metals such as gold with which the alkanethiol is coupled, but as illustrated in FIG. 33A, when the antibody is coupled only with the insulating portion, the substance of the electrode 3202 is not limited to precious metals and may be formed of titanium nitride, titanium, tungsten, and the like.

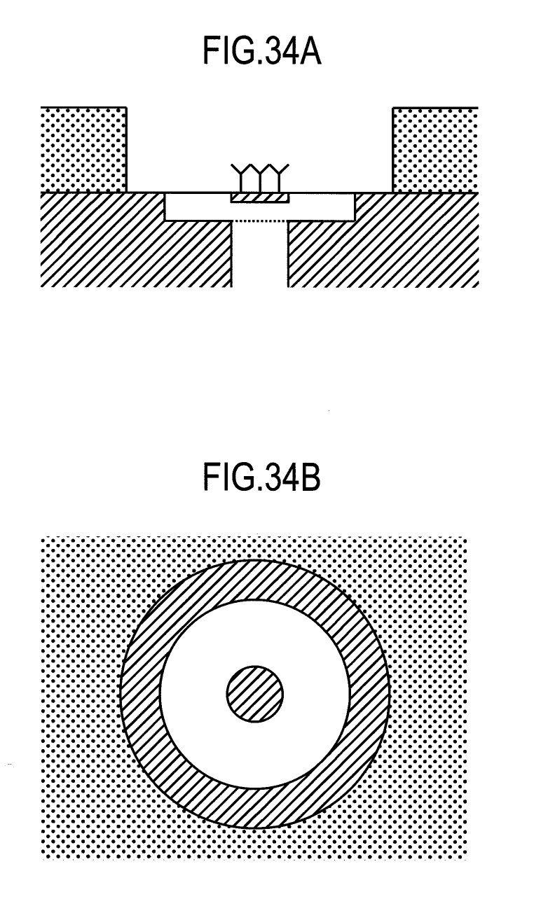

FIGS. 34A and 34B illustrate another example of the case in which the donut-shaped electrode is used. Since the sidewall is in the vicinity of the electrode, the change in signal due to the coupling of the subjects to be assayed is more increased than in FIG. 32.

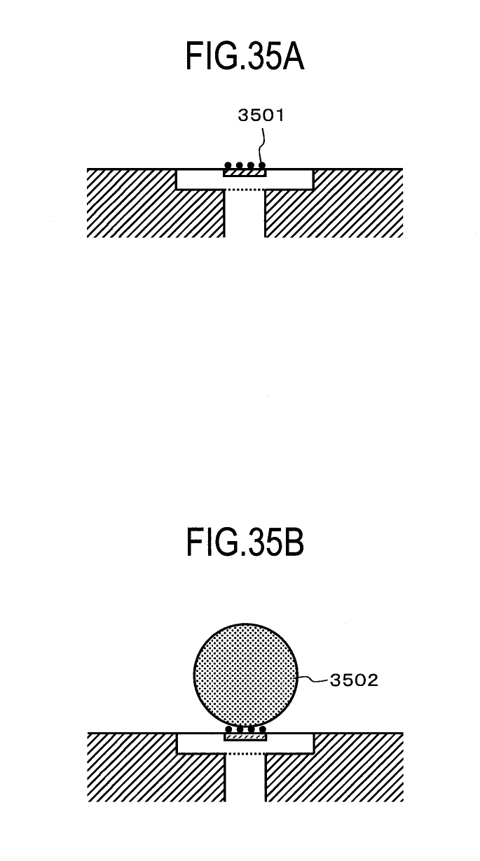

FIGS. 35A and 35B illustrate another example of the case in which the donut-shaped electrode is used. A particulate 3501 having the coupling capability with the surface of the insulating portion of the center of the electrode is disposed on the insulating portion (FIG. 35A). A substance that is coupled with the subject to be assayed such as the antibody, and the like, is immobilized to the particulate. For this reason, a subject 3502 to be assayed is coupled on the electrode via the particulate (FIG. 35B). In this case, the insulating portion may be disposed at a location more depressed than the electrode as much as the size of the particulate. In order to reuse the electrode after the assay ends, a substance that weakens the coupling of the particulate and the insulating portion may be introduced and the particulate may be removed from the electrode.

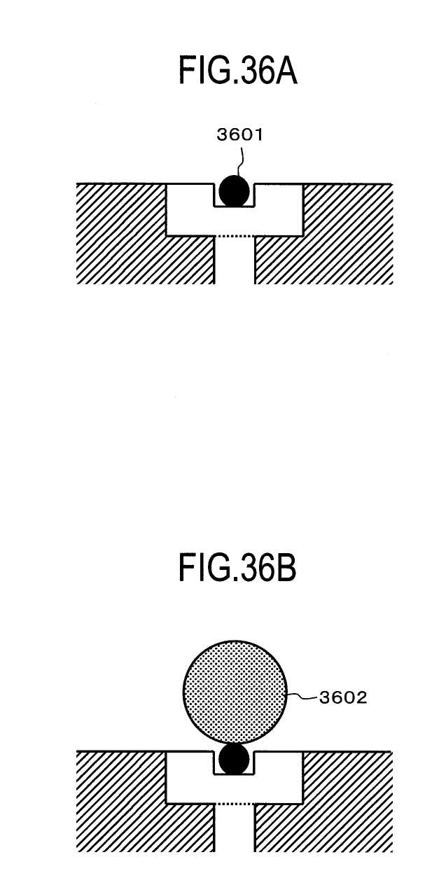

FIGS. 36A and 36B illustrate another example of the case in which the donut-shaped electrode is used. A concave portion is present at the center of the electrode and the magnetic bead is disposed in the concave portion (FIG. 36A). A substance that is coupled with the subject to be assayed such as the antibody, and the like, is immobilized to the magnetic bead. For this reason, the subject to be assayed is coupled on the electrode via the magnetic bead (FIG. 36B). After the assay ends, the magnetic bead is removed from the electrode by pulling the magnetic bead with magnetic field, a new magnetic bead is disposed on the electrode, and the following assay may be performed.

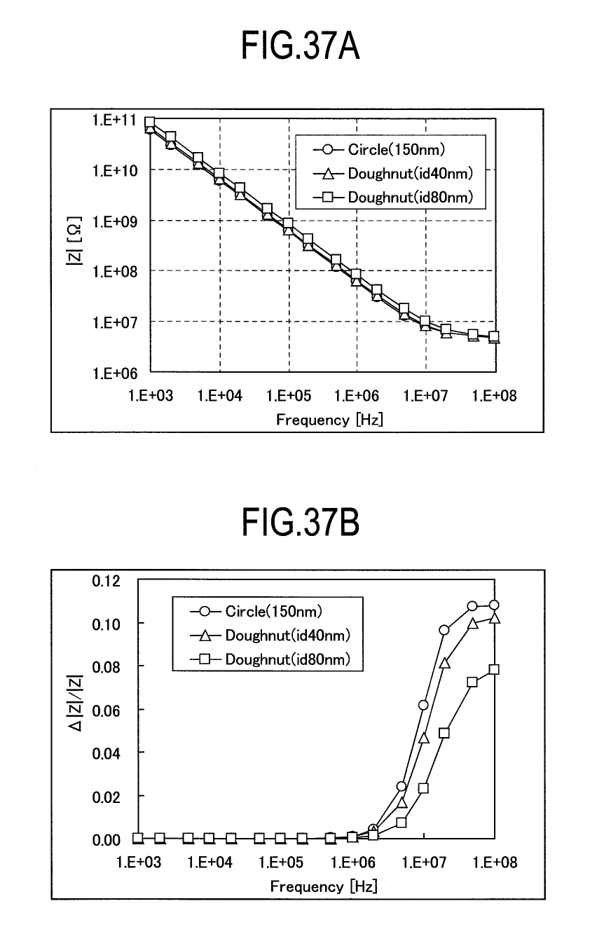

FIGS. 37A and 37B are graphs illustrating the calculated results when the detection of the spherical body selected as the subject to be assayed is performed using the donut-shaped electrode illustrated in FIG. 32. The case in which the electrode represented by a circle uses the disc-shaped electrode having a diameter of 150 nm illustrated in FIG. 4, the case in which the electrode represented by id40 nm uses the electrode having an outer diameter of 150 nm and an inner diameter of 40 nm as the donut-shaped electrode illustrated in FIG. 32, and the case in which the electrode represented by id80 nm uses the electrode having an outer diameter of 150 nm and an inner diameter of 80 nm as the donut-shaped electrode illustrated in FIG. 32 are shown. The absolute value of impedance (FIG. 37A) and the change in impedance (FIG. 37B) due to the coupling of the subject to be assayed that is a spherical body having a diameter of 100 nm are obtained in a numerical analysis manner using the finite element method. It can be appreciated that when comparing with the disc-shaped electrode, in the donut-shaped electrode having an inner diameter of 40 nm, the change rate of impedance due to the coupling of the subjects to be assayed is reduced to about 5% and the subjects to be assayed can be detected as a donut shape. Further, in the donut-shaped electrode having an inner diameter of 60 nm, the change rate of impedance is reduced to 27%, but the change in impedance of 8% is still observed and the detection can be performed similarly.

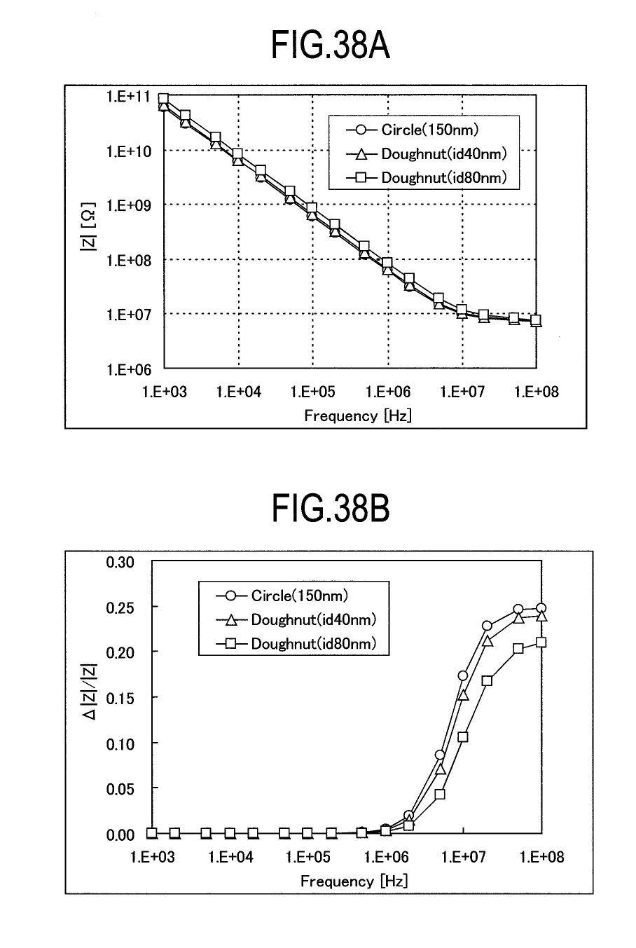

FIGS. 38A and 38B are graphs illustrating the calculated results when the detection of the spherical body selected as the subject to be assayed is performed using the donut-shaped electrode illustrated in FIG. 34. The case in which the electrode represented by a circle uses the electrode having a diameter of 150 nm as the disc-shaped electrode illustrated in FIG. 13, the case in which the electrode represented by id40 nm uses the electrode having an outer diameter of 150 nm and an inner diameter of 40 nm as the donut-shaped electrode illustrated in FIG. 34, and the case in which the electrode represented by id80 nm uses the electrode having an outer diameter of 150 nm and an inner diameter of 80 nm as the donut-shaped electrode illustrated in FIG. 34 are shown. The diameter of the sidewall is set to be 150 nm like the outer diameter of the electrode. The absolute value of impedance (FIG. 38A) and the change in impedance (FIG. 38B) due to the coupling of the subject to be assayed that is a spherical body having a diameter of 100 nm are obtained in a numerical analysis manner using the finite element method. When comparing with the disc-shaped electrode, it can be appreciated that in the donut-shaped electrode having an inner diameter of 40 nm, there is an effect in that the change rate of impedance due to the coupling of the subjects to be assayed is suppressed to the reduction of about 3% and the sidewall reduces the difference with the donut-shaped electrode in the donut-shaped electrode. In addition, even in the donut-shaped electrode having an inner diameter of 60 nm, the change rate is suppressed to the reduction of 15%.

From the results of FIGS. 37 and 38, it can be appreciated that the subject to be assayed can be detected from the change in impedance even when the donut-shaped electrode is used and when comparing with the disc-shaped electrode, the change rate of impedance due to the coupling of the subjects to be assayed becomes slightly small, but in the present assay, in order to detect the presence or absence of the subject to be assayed from the change rate of impedance, the slight difference of the change rate of impedance does not affect the fixed quantity of the subject to be assayed in principle. Further, when the side wall is disposed in the vicinity of the donut-shaped electrode, similar to the case of the disc-shaped electrode, the change rate of impedance is increased and the difference in the change rate of impedance between the donut-shaped electrode and the disc-shaped electrode becomes small. Therefore, it can be appreciated that the place where the subjects to be assayed are coupled is limited to the electrode central portion and the reproducibility of the change in signal when the subjects to be assayed are coupled is increased, while maintaining the function of detecting the subject to be assayed by using the donut-shaped electrode.

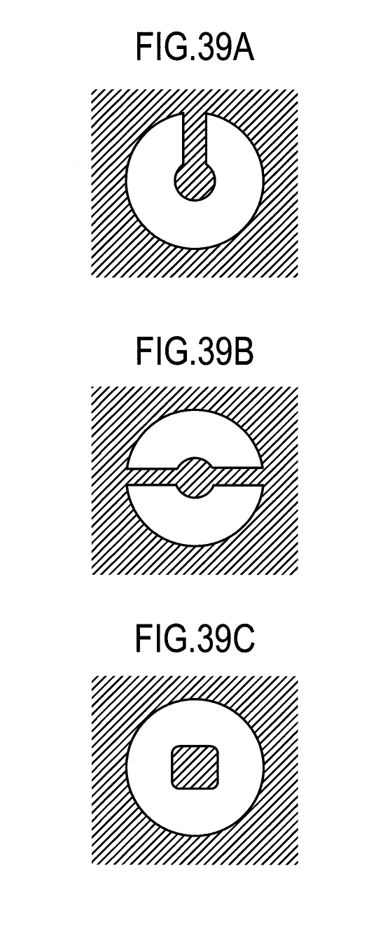

The donut-shaped electrode described in FIGS. 32 to 38 may have a shape in which a part of the electrode has a notch (FIG. 39A), the electrode may be divided into a plurality of portions (FIG. 39B), or the insulating portion at the center thereof may have a square, a circle, and the like (FIG. 39C).

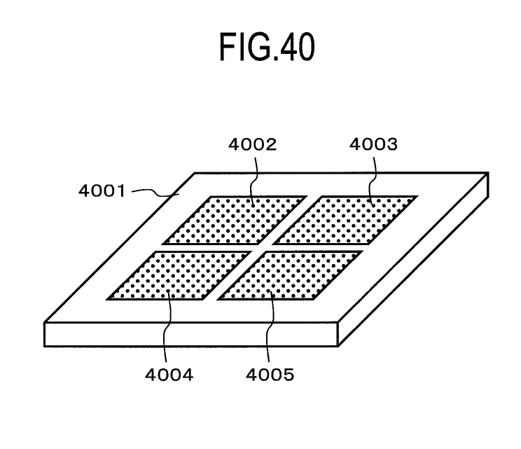

FIG. 40 is an example of a chip in which the electrodes corresponding to the multiple types of bacteria are mixed. A chip 4001 is provided with four areas 4002 to 4005, and each area is formed as the electrode array as illustrated in FIG. 2 and for example, the area 4002 is immobilized with an antibody corresponding to enteropathogenic Escherichia coli (O157), the area 4003 is immobilized with an antibody corresponding to staphylococcus aureus, and the area 4003 is immobilized with an antibody corresponding to salmonella, and the area 4003 is immobilized with an antibody corresponding to campylobacter. In addition, in the case of the example, the electrodes of each area are optimized as the size of each bacteria (enteropathogenic Escherichia coli O157: 0.5×1.0 to 3.0 μm, staphylococcus aureus: 0.8×1.0 μm, salmonella: 0.6 to 3.0×0.6 to 1.0 μm, and campylobacter: 0.5 to 5×0.2 to 0.8 μm). The number of subjects to be assayed for each area is assayed according to the flow of FIG. 7 or 10. The multiple types of bacteria in a specimen such as food, water, excreta, and the like, may be investigated at a time by using the chip 4001.

### REFERENCE SINGS LIST

101 base
102 specimen introduction part
103 conjugate pad
104 membrane
105 test line
106 control line
107 absorbent pad
108 labeled antibody
109, 110 immobilized antibody
201, 301, 401, 501, 1101, 1201, 1301, 1401, 1501, 1601, 1701, 1801, 1901, 3201 substrate
202, 302, 402, 502, 1102, 1202, 1302, 1402, 1502, 1602, 1702, 1802, 1902, 3202 electrode
203, 303, 403, 503, 1103, 1203, 1303, 1403, 1503, 1603, 1703, 1803, 1903, 3203 wiring
1204, 1304, 1404, 1504, 1604 sidewall
3204 insulating portion
404, 504, 1305, 1405, 1804, 1904, 3205 antibody
505, 1406, 1905 subject
601 assay unit
602, 912 electrode array chip
603 container
604 assay solution
605, 903 counter electrode
606, 914 multiplexer
607, 910 impedance assaying device
608, 902 control unit
609 data processing device
610 arithmetic unit
611 temporary memory
612 nonvolatile memory
613 data display device
901 assay unit
903 assay container
904 pump
905, 911 channel
906 specimen syringe
907 valve
908 assay cell
909 waste liquid container
4001 chip
4002 area

1. An array, comprising:
a substrate;
multiple electrodes disposed on a surface of the substrate;
wirings connected with each of the multiple electrodes and disposed at an opposite side to the surface of the substrate; and
a probe capturing subjects to be assayed on the electrodes.

2. The array according to claim 1, wherein a size of the electrode is a size that makes a pair with the subjects to be assayed.

3. The array according to claim 1, wherein the electrodes are buried in the substrate.

4. The array according to claim 1, wherein a sidewall using the electrode as a bottom surface is formed.

5. The array according to claim 1, wherein the electrode has a concave shape.

6. The array according to claim 1, wherein the electrode has a size of a half or more or two times or less of a size of the subject to be arrayed.

7. The array according to claim 1, wherein the probes on the multiple electrodes are the same type of probe.

8. The array according to claim 1, wherein the probe is an antibody or a virus recognition portion.

9. The array according to claim 1, wherein the subject to be assayed is any one of cells, bacterium, virus, bead, and liposome.

10. An assay system, comprising:
a unit contacting a sample solution on an array including a substrate, multiple electrodes disposed on a surface of the substrate, wirings connected with each of the multiple electrodes and disposed at an opposite side to the surface of the substrate, and a probe capturing subjects to be assayed on the electrodes;
a counter electrode contacting the sample solution; and
an assaying device assaying impedance between each of the multiple electrodes disposed on the array and the counter electrode.

11. The assay system according to claim 10, wherein the counter electrode is disposed on the array.

12. The assay system according to claim 10, wherein the unit contacting the sample solution on the array is a channel disposed on the array.

13. The assay system according to claim 10, wherein the channel includes a sample solution introduction part disposed at a sample inlet side of the array and a sample outlet part disposed at a sample outlet side of the array.

14. The assay system according to claim 10, further comprising:
a control unit detecting capturing of subjects to be assayed by a size of the impedance and counting the number of captured subjects to be assayed.

15. An assay method, comprising the steps of:
introducing a sample solution on an array including a substrate, multiple electrodes disposed on a surface of the substrate, wirings connected with each of the multiple electrodes and disposed at an opposite side to the surface of the substrate, and a probe capturing subjects to be assayed on the electrodes;
assaying impedance between each of the multiple electrodes and a counter electrode contacting the sample solution; and
detecting presence or absence of capturing of the subjects to be assayed in each of the electrodes and counting the number of captured subjects to be assayed, by a size of the impedance.

16. The assay method according to claim 15, wherein the presence and absence of the capturing of the subjects to be assayed is detected from a change in impedance after and before the step of introducing the sample solution.

17. The array according to claim 1, wherein an insulating portion is formed on the electrode and the probe is disposed on the insulating portion.

18. The array according to claim 1, wherein the insulating portion is formed on the electrode and a coupled particulate of the probe is immobilized to the insulating portion.

19. The array according to claim 1, wherein a concave portion is disposed on the electrode and a coupled particulate of the probe is disposed on the concave portion.

20. An array in which the multiple arrays according to claim 7 are arranged and the probes of the arranged multiple arrays are different from each other.
